(19) United States
(12) Patent Application Publication
(10) Pub. No.: US 2026/0263908 A1
(43) Pub. Date: Sep. 10, 2026

(54) LOTTERY TICKET SELLING SYSTEMS AND METHODS OF OPERATION THEREOF THAT EMPLOY TERMINAL INTERCEPTORS FOR LOTTERY TERMINALS

(71) Applicant: Brightstar Global Solutions Corporation, Providence, RI (US)

(72) Inventors: Paul Schneider, Jerome, ID (US); Apostolos D. Kallis, Barrington, RI (US); Christopher Lowrie, El Dorado Hills, CA (US)

(21) Appl. No.: 19/071,478

(22) Filed: Mar. 5, 2025

(51) Int. Cl. A63F 3/06

(52) U.S. Cl. CPC A63F 3/061; A63F 3/0655

(57) ABSTRACT

Lottery ticket selling systems and methods of operating the systems that enable the purchase of a draw lottery ticket using a ticket purchase identifier, wherein the system includes an electronic ticket retail server, a terminal interceptor, and a lottery terminal.

### BACKGROUND

The present disclosure relates to lottery ticket selling systems that employ terminal interceptors for lottery terminals.

For a draw lottery ticket for a draw lottery game, a player may select the player numbers or may have an electronic lottery system randomly select the player numbers (which is often referred to as a quick pick). Draw lottery tickets may be purchased in variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates to lottery ticket selling systems that employ terminal interceptors for lottery terminals.

In various embodiments, the present disclosure relates to a lottery ticket selling system comprising a lottery terminal comprising a printer connector and a code reader connector that is connectable to a code reader, a lottery ticket printer associated with the lottery terminal and comprising a terminal connector that is connectable to the printer connector, a terminal interceptor comprising: a terminal code reader connector connected to the code reader connector of the lottery terminal; a terminal printer connector connected to the printer connector of the lottery terminal; a printer terminal connector connected to the terminal connector of the lottery ticket printer; and an interceptor processor and an interceptor memory device that stores a first plurality of instructions; and an electronic ticket retail server comprising a server processor and a server memory device that stores a second plurality of instructions. The second plurality of instructions, when executed by the server processor, cause the server processor to: receive a lottery ticket order from a player electronic device associated with an original purchaser, the lottery ticket order comprising bet details for a purchase of a draw lottery ticket; generate a ticket purchase identifier for the draw lottery ticket prior to the purchase of the draw lottery ticket, wherein the original purchaser is uniquely identifiable using the ticket purchase identifier; generate bet slip data that comprises the bet details for the draw lottery ticket; and send the bet slip data to the terminal interceptor. The first plurality of instructions stored on the interceptor memory device, when executed by the interceptor processor, cause the interceptor processor to: generate bet slip scan data based on the bet slip data; send the bet slip scan data to the lottery terminal via the terminal code reader connector to cause the purchase of the draw lottery ticket based on the bet slip scan data; receive a ticket image response from the lottery terminal via the terminal printer connector, the ticket image response comprising ticket details for the purchased draw lottery ticket; obtain the ticket details from the ticket image response and send the ticket details to the electronic ticket retail server. The second plurality of instructions stored on the server memory device, when executed by the server processor, cause the server processor to: generate a ticket purchase trailer that comprises the ticket purchase identifier and send the ticket purchase trailer to the terminal interceptor; The first plurality of instructions stored on the interceptor memory device, when executed by the interceptor processor, cause the interceptor processor to: generate an augmented ticket image response based on the ticket image response and the ticket purchase trailer; and send the augmented ticket image response to the lottery ticket printer via the printer terminal connector to cause the lottery ticket printer to print the purchased draw lottery ticket, the printed draw lottery ticket comprising the ticket details and the ticket purchase trailer.

In various other embodiments, the present disclosure relates to a lottery ticket selling system comprising a terminal interceptor comprising: a terminal code reader connector that is connectable to a code reader connector of a lottery terminal; a terminal printer connector that is connectable to a printer connector of the lottery terminal; a printer terminal connector that is connectable to a terminal connector of a lottery ticket printer; and an interceptor processor and an interceptor memory device that stores a first plurality of instructions. The first plurality of instructions stored on the interceptor memory device, when executed by the interceptor processor, cause the interceptor processor to: receive, from an electronic ticket retail server, bet slip data that comprises bet details for a purchase of a draw lottery ticket for an original purchaser; generate bet slip scan data based on the bet slip data; send the bet slip scan data to the lottery terminal via the terminal code reader connector to cause the purchase of the draw lottery ticket based on the bet slip scan data; receive a ticket image response from the lottery terminal via the terminal printer connector, the ticket image response comprising ticket details for the purchased draw lottery ticket; obtain the ticket details from the ticket image response and send the ticket details to the electronic ticket retail server; receive a ticket purchase trailer that comprises a ticket purchase identifier, wherein the original purchaser is uniquely identifiable using the ticket purchase identifier; generate an augmented ticket image response based on the ticket image response and the ticket purchase trailer; and send the augmented ticket image response to the lottery ticket printer via the printer terminal connector to cause the lottery ticket printer to print the purchased draw lottery ticket, the printed draw lottery ticket comprising the ticket details and the ticket purchase trailer.

In various other embodiments, the present disclosure relates to a lottery ticket selling system comprising a lottery ticket scanner, a terminal interceptor comprising: a terminal code reader connector that is connectable to a code reader connector of a lottery terminal; a terminal printer connector that is connectable to a printer connector of the lottery terminal; a printer terminal connector that is connectable to a terminal connector of a lottery ticket printer; and an interceptor processor and an interceptor memory device that stores a first plurality of instructions, an electronic ticket retail server comprising a server processor and a server memory device that stores a second plurality of instructions. The second plurality of instructions, when executed by the server processor, cause the server processor to: receive a lottery ticket order from a player electronic device associated with an original purchaser, the lottery ticket order comprising bet details for a purchase of a draw lottery ticket; generate a ticket purchase identifier for the draw lottery ticket prior to the purchase of the draw lottery ticket, wherein the original purchaser is uniquely identifiable using the ticket purchase identifier; generate bet slip data that comprises the bet details for the draw lottery ticket; and send the bet slip data to the terminal interceptor. The first plurality of instructions stored on the interceptor memory device, when executed by the interceptor processor, cause the interceptor processor to: generate bet slip scan data based on the bet slip data; send the bet slip scan data to the lottery terminal via the terminal code reader connector to cause the purchase of the draw lottery ticket based on the bet slip scan data; receive a ticket image response from the lottery terminal via the terminal printer connector, the ticket image response comprising ticket details for the purchased draw lottery ticket; obtain the ticket details from the ticket image response and send the ticket details to the electronic ticket retail server. The second plurality of instructions stored on the server memory device, when executed by the server processor, cause the server processor to: generate a ticket purchase trailer that comprises the ticket purchase identifier and send the ticket purchase trailer to the terminal interceptor. The first plurality of instructions stored on the interceptor memory device, when executed by the interceptor processor, cause the interceptor processor to: generate an augmented ticket image response based on the ticket image response and the ticket purchase trailer; send the augmented ticket image response to the lottery ticket printer via the printer terminal connector to cause the lottery ticket printer to print the purchased draw lottery ticket such that the lottery ticket scanner can scan the printed draw lottery ticket to obtain scanned draw lottery ticket data, the printed draw lottery ticket comprising the ticket details and the ticket purchase trailer; and receive the scanned draw lottery ticket data from the lottery ticket scanner and send the scanned draw lottery ticket data to the player electronic device via the electronic ticket retail server.

Additional features are described in, and will be apparent from, the following Detailed Description and the figures.

### BRIEF DESCRIPTION OF THE SEVERAL VIEWS OF THE DRAWINGS

FIG. 1 is front view of an example draw lottery ticket.

FIG. 2 is a diagrammatic view of a known lottery ticket selling system, showing a courier server that employs a bet slip to enable a purchase of a draw lottery ticket such as the draw lottery ticket of FIG. 1.

FIG. 3A is a diagrammatic view of an example lottery ticket selling system that includes a terminal interceptor that connects to a lottery terminal and a lottery ticket printer in accordance with one example embodiment of the present disclosure.

FIG. 3B is a perspective view of the example lottery ticket selling system of FIG. 3A, diagrammatically showing the terminal interceptor providing an augmented ticket image response including a ticket purchase trailer to a lottery ticket printer in accordance with one example embodiment of the present disclosure.

FIGS. 4A, 4B, and 4C are front views of example draw lottery tickets and ticket purchase trailers, in accordance with one example embodiment of the present disclosure.

FIG. 5 is a flow diagram showing one example method of operation of the lottery ticket selling system of FIG. 3A for a draw lottery ticket purchase by an original purchaser in accordance with one example embodiment of the present disclosure.

FIG. 6 is a flow diagram showing one example method of operation of the lottery ticket selling system of FIG. 3A for a draw lottery ticket redemption by an original purchaser in accordance with one example embodiment of the present disclosure.

FIG. 7 is a diagrammatic view of another example lottery ticket selling system that includes an electronic ticket retail server and a terminal interceptor that employ a ticket purchase trailer to enable identification of an original purchaser of a draw lottery ticket in accordance with one example embodiment of the present disclosure.

FIG. 8A is a flow diagram showing one example method of operation of the lottery ticket selling system of FIG. 7 for a draw lottery ticket purchase by an original purchaser in accordance with one example embodiment of the present disclosure.

FIG. 8B is a flow diagram showing one example method of operation of the lottery ticket selling system of FIG. 7 for printing a draw lottery ticket by an original purchaser in accordance with one example embodiment of the present disclosure.

FIG. 9A is a flow diagram showing one example method of operation of the lottery ticket selling system of FIG. 7 for validating a draw lottery ticket by an original purchaser in accordance with one example embodiment of the present disclosure.

FIG. 9B is a flow diagram showing one example method of operation of the lottery ticket selling system of FIG. 7 for providing a winning amount for a winning draw lottery ticket to an original purchaser in accordance with one example embodiment of the present disclosure.

### DETAILED DESCRIPTION

In various embodiments, the present disclosure relates generally to lottery ticket selling systems and methods of operating the lottery ticket selling systems, wherein the lottery ticket selling systems include a terminal interceptor that connects to a lottery terminal and a lottery ticket printer. The terminal interceptor enables printing of a draw lottery ticket that includes a ticket purchase trailer that is employable to associate the draw lottery ticket with an original purchaser of that draw lottery ticket. The ticket purchase trailer includes a ticket purchase identifier that is generated for the draw lottery ticket prior to a purchase of that draw lottery ticket.

In various embodiments, the lottery ticket selling system includes: (a) a player electronic device with a mobile application downloaded thereon; (b) an electronic ticket retail server; (c) a terminal interceptor; (d) a lottery terminal; (e) a lottery central system; and (f) a lottery ticket printer.

In various other embodiments, the lottery ticket selling system includes: (a) an electronic ticket retail server; (b) a terminal interceptor; (c) a lottery terminal; and (d) a lottery ticket printer, wherein the electronic ticket retail server is configured to communicate with each of a plurality of player electronic devices.

In various other embodiments, the lottery ticket selling system includes: (a) an electronic ticket retail server; (b) a terminal interceptor; and (c) a lottery ticket printer, wherein the electronic ticket retail server is configured to communicate with each of a plurality of player electronic devices.

In various embodiments, the lottery ticket selling system enables: (1) an original purchaser to employ a player electronic device to cause a purchase of a draw lottery ticket without visiting a lottery terminal at a retail location; and (2) generation of a ticket purchase trailer or other suitable ticket purchase identifier that is employable to associate the purchased draw lottery ticket with the original purchaser.

In various other embodiments, the lottery ticket selling system enables: (1) an original purchaser to employ a player electronic device to cause a purchase of a draw lottery ticket without visiting a lottery terminal at a retail location; (2) prior to the purchase of the draw lottery ticket, generation of a ticket purchase identifier employable to associate the purchased draw lottery ticket with the original purchaser; (3) purchase of the draw lottery ticket; (4) augmenting ticket image data for the draw lottery ticket to include the ticket purchase identifier; and (5) printing of the purchased draw lottery ticket with the ticket purchase identifier.

In various other embodiments, the lottery ticket selling system enables: (1) an original purchaser to employ a player electronic device to cause a purchase of a draw lottery ticket without visiting a lottery terminal at a retail location; (2) prior to the purchase of the draw lottery ticket, generation of a ticket purchase identifier employable to associate the purchased draw lottery ticket with the original purchaser; (3) purchase of the draw lottery ticket; (4) capturing a ticket image response for printing of the purchased draw lottery ticket; (5) augmenting the ticket image response to include the ticket purchase identifier; and (6) printing of the draw lottery ticket with the ticket purchase identifier.

Draw lottery tickets for draw lottery games are employed as example lottery tickets herein; however, it should be appreciated that the present disclosure is not meant to be limited by such examples.

For a better understanding of the present disclosure, an example draw lottery ticket is first described herein.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

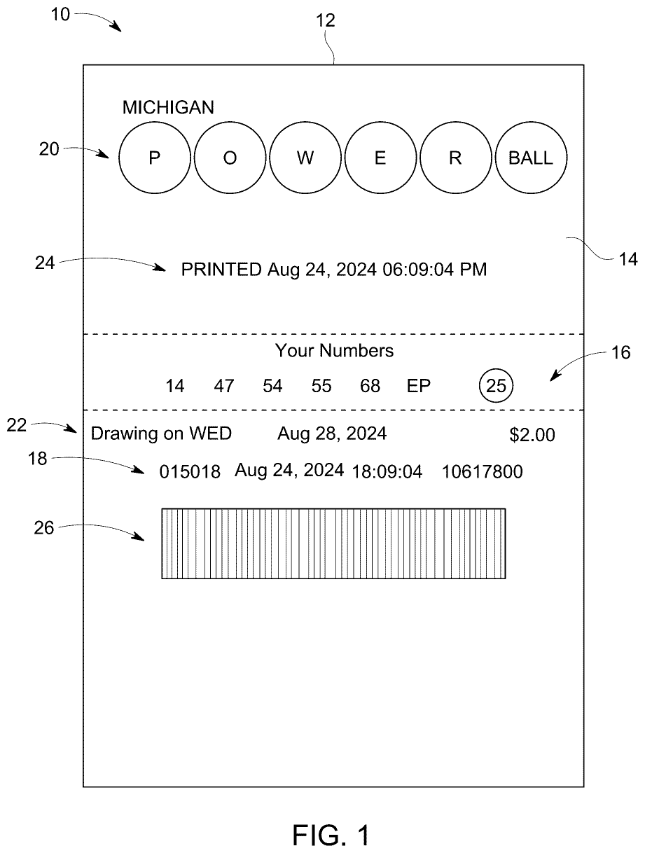

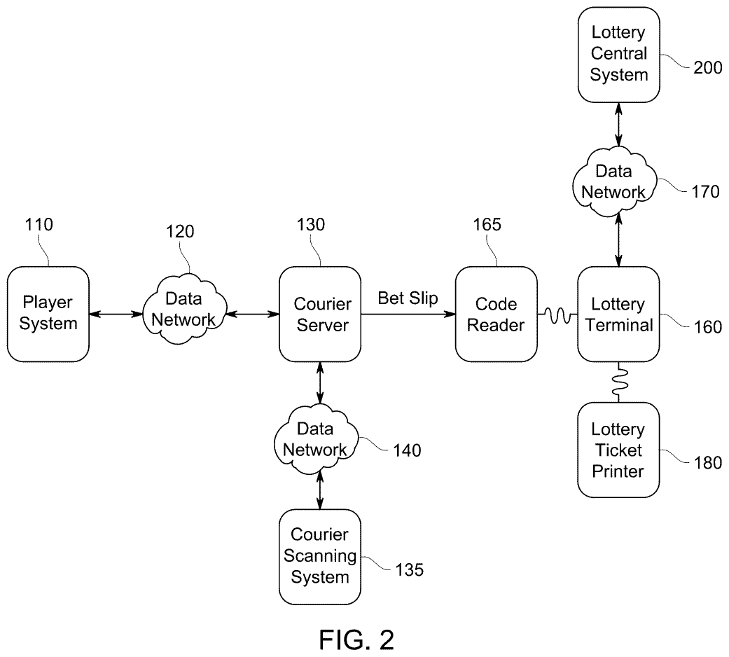

An example physical draw lottery ticket 10 is shown in FIG. 1. This example draw lottery ticket includes: (1) a ticket substrate 12; (2) a front surface 14 of the ticket substrate 12; (3) lottery ticket information, including a single set of player numbers (for a single play of draw lottery game), printed on the front surface 14 of the ticket substrate 12; and (4) a back surface (not shown) of the ticket substrate 12. This example draw lottery ticket 10 is for a single play of a draw lottery game (scheduled to take place on Wednesday Aug. 28, 2024) and includes a single set of player numbers 16 (i.e., player numbers for the single play of the draw lottery game). The lottery ticket information in this example includes player numbers 16, a ticket identifier 18 that uniquely identifies the lottery ticket 10, a game identifier 20 that identifies the lottery game type, a draw date 22 associated with the ticket 10, and a print date 24 on which the ticket 10 was printed. It should be appreciated that while this draw lottery ticket is for a single play, draw lottery tickets often include multiple sets of player numbers that are for a single play of the draw lottery game. The lottery ticket information can include text, one or more ticket numbers (shown as the ticket identifier 18), one or more ticket barcodes (shown as barcode 26), and other lottery ticket information that is in either or both human readable and machine-readable forms. The lottery ticket's barcode 26 is configured to be scanned by a barcode reading device to enable redemption of such draw lottery ticket.

Additionally, for a better understanding of the present disclosure, an example known system and method employed for purchasing draw lottery tickets is also now described.

Various jurisdictions (such as various states) do not permit remote or electronic purchase of draw lottery tickets, and in various such jurisdictions, an example known lottery ticket system using a courier service has been employed. Turning to FIG. 2, an example known courier system 100 (or “system 100”) includes: (a) a player system 110 with a courier mobile application downloaded thereon; (b) a courier server 130; (c) a courier scanning system 135; (d) a lottery terminal 160; (e) a code reader 165 associated with the lottery terminal 160; (f) a lottery ticket printer 180; and (g) a lottery central system 200.

The player system 110 and the courier server 130 are configured to communicate with each other via a data network 120. The courier server 130 and the courier scanning system 135 are configured to communicate with each other via a data network 140. The lottery terminal 160 and the code reader 165 are configured to communicate with each other via hard wire such as an USB connector. The lottery terminal 160 and the lottery ticket printer 180 are configured to communicate with each other via hard wire such as an USB connector. The lottery terminal 160 and the lottery central system 200 are configured to communicate with each other via a data network.

The player system 110 includes a player electronic device, such as a smartphone with the courier mobile application downloaded thereon. The player system 110 is employable by an original purchaser (also sometimes referred to herein as a “player”) to purchase a draw lottery ticket.

The courier server 130 includes a server configured to receive bet details from the player system 110 via the courier mobile application and to generate a suitable bet slip for the draw lottery game based on the bet details. The bet slip includes lottery ticket information, such as a player's selected numbers or quick pick numbers for a selected play of a selected draw lottery game. The bet slip(s) are provided to the lottery terminal 160 for printing of draw lottery tickets.

The courier scanning system 135 includes an image capture device configured to scan a printed draw lottery ticket to obtain scanned ticket image data. The courier scanning system 135 provides the scanned ticket image data to the courier server 130.

The lottery terminal 160 enables an original purchaser and/or operator of the lottery terminal 160 to use such components to input lottery ticket purchase data for selecting and paying for draw lottery tickets that the original purchaser desires to obtain. That is, the lottery terminal 160 generates the lottery ticket information for the lottery ticket based on user inputs (e.g., bet details) from the original purchaser and/or operator of the lottery terminal 160 via the purchaser interface components.

The lottery ticket printer 180 is configured to receive lottery ticket printing data from the lottery terminal 160 and print a physical lottery ticket based on the lottery ticket printing data.

The lottery central system 200 includes a server configured to provide draw lottery games and to facilitate the purchase, validation, and redemption of draw lottery tickets for such draw lottery games.

The courier system 100 has been used to enable players to remotely electronically purchase draw lottery tickets for draw lottery games wherein the courier service conducts various physical steps of the lottery ticket purchase process on behalf of the players. More specifically, this known system enables a purchase of a draw lottery ticket for a draw lottery game remotely. A player uses the player system 110 (such as an application on their smartphone) to purchase a draw lottery ticket (which can include the player inputting the player's selected numbers or a quick pick indication for the draw lottery game). This application is referred to as a courier mobile application.

The courier mobile application functions to create bet details (including the player's selected numbers, quick pick numbers that the courier mobile application randomly selected, or a quick pick indication for a lottery terminal to randomly select the quick pick numbers) and causes the player's smartphone to send the bet details via the data network 120 to the courier server 130 at a courier processing center. The courier server 130 uses the received bet details to create and cause a courier printer (not shown) to physically print a physical paper bet slip for the play of the draw lottery game at the courier processing center. The bet slip includes the bet details, such as the player numbers or the quick pick indication.

A human courier processing clerk takes the printed paper bet slip for the play of the draw lottery game to an operator of the lottery terminal 160 at a physical location of the lottery terminal 160 that is remote from the courier processing center. The operator uses the code reader 165 associated with the lottery terminal 160 to scan the printed paper bet slip. The code reader 165 creates bet slip scan data for the draw lottery ticket, and a terminal application of the lottery terminal 160 uses that bet slip scan data to determine the player numbers for the play of the draw lottery game and to create the lottery ticket. The lottery terminal 160 causes the lottery ticket printer 180 to print out the draw lottery ticket with the player numbers. The operator of the lottery terminal 160 also collects the payment for the draw lottery ticket from the courier processing clerk and provides the printed draw lottery ticket to the courier processing clerk. The courier processing clerk then takes the printed bet slip and the printed draw lottery ticket back to the courier processing center.

The courier processing clerk scans the printed draw lottery ticket using the courier scanning system 135 connected to the courier server 130. The courier server 130 links the scanned draw lottery ticket back to a player account established through the courier mobile application. The courier server 130 then makes the scanned lottery ticket available for the player to view via the courier mobile application on the player system 110. The courier processing clerk places the printed bet slip and the printed draw lottery ticket in secure courier storage locations for storage if needed at a later time.

After the draw for the play of the draw lottery game takes place, if the player's lottery ticket is a winning lottery ticket and the winning amount is less than $600, the courier server automatically credits the winning amount for the player's draw lottery ticket to the player's account. The courier service can then retrieve and redeem the stored actual winning printed draw lottery ticket at a location having a lottery terminal. After the draw for the draw lottery game takes place, if the player's lottery ticket is a winning lottery ticket and the winning amount is $600 or more, a courier processing clerk retrieves the stored winning physical player lottery ticket from the courier storage location and sends that printed draw lottery ticket to the player so that the player can cash in that lottery ticket and obtain the winning amount.

For a better understanding of various embodiments of the lottery systems and methods of the present disclosure, certain encryption, decryption, and hashing systems and methods are now described.

In cryptography, encryption is the process of encoding information. This process converts the original representation of the information (known as plaintext) into an alternative form (known as ciphertext). Ideally, only authorized parties can decipher a ciphertext back to plaintext and access the original information. Encryption does not itself prevent interference but denies the intelligible content to a would-be interceptor. Encryption can be performed using a secret key of some kind. It is thus generally only possible to decrypt the ciphertext if the secret key is known. There is typically no loss of information between the original text or decrypted ciphertext. The encryption process can include chained encryption where the result of the first encryption is encrypted again using a different secret key. Chained encryption can include performing the encryption process one or more additional times with different secret keys. Decryption is performed backward using the last secret key, then the next to last secret key, etc.

Hashing is a function that is used to map data of an arbitrary size to a static-size value, though there are some hash functions that provide a variable length output. The value returned by a hash function is called a hash value, a hash code, a hash digest, a digest, or simply a hash. Hashing is a one-way function. In other words, once an original text has been hashed, it is not normally feasible to determine the original text if only the hash is known. Typically, determining the original text using the hash value can be done only by trying all possible original texts and determining if the hash of each candidate is the same as the hash of the original. By adding additional secret text to the original text, it is possible to lengthen the calculations and thus time required to try all possible values. This is called salting the hash. Another option for hashing is a keyed hash. This is a different kind of hash function (sometimes called a hash message authentication code, or HMAC) where the hash is performed on the original data, and this hashing method uses a separate set of data called a key. By varying the key, the same original text can hash into different hashed results.

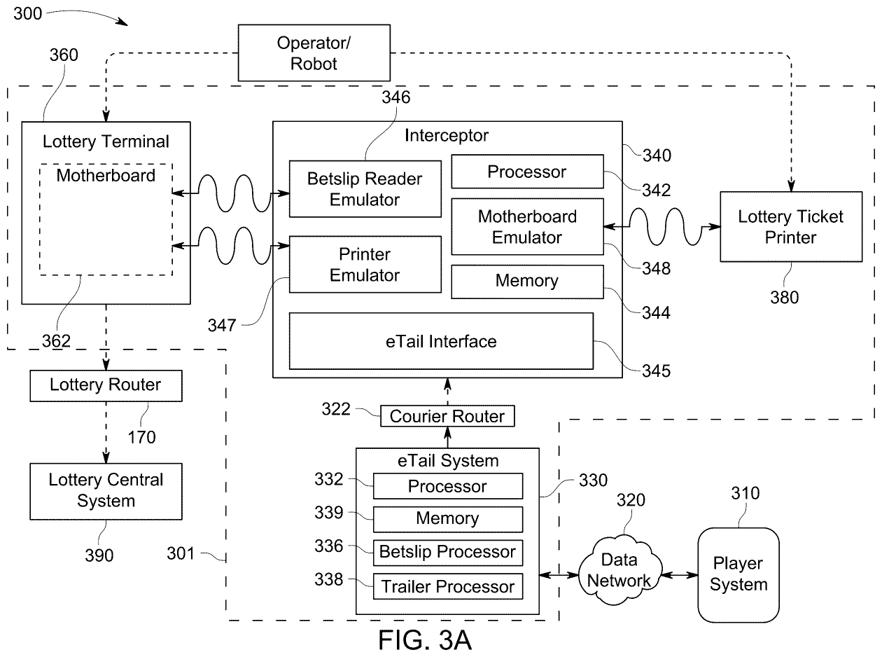

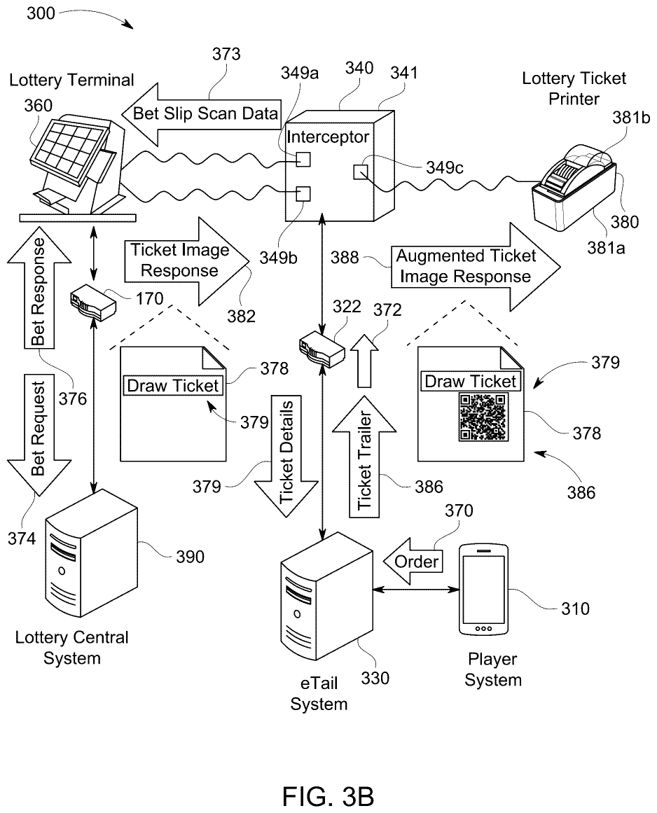

Turning now to FIG. 3A and FIG. 3B, an example lottery ticket selling system 300 in accordance with one example embodiment of the present disclosure is shown.

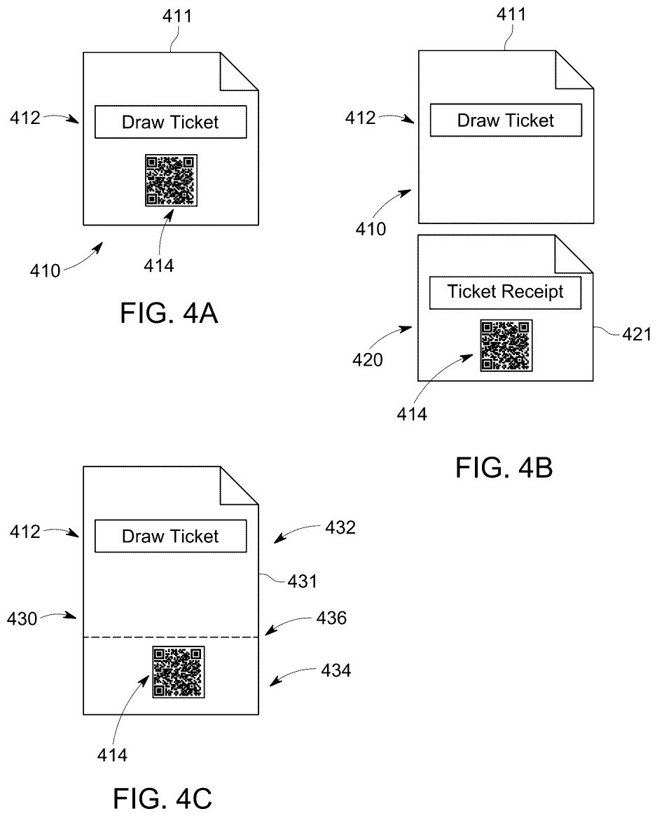

An example embodiment of a printed draw lottery ticket 410 employed and augmented by the lottery ticket selling system 300 is shown in FIG. 4A.

An example embodiment of the printed draw lottery ticket 410 and a separate printed ticket receipt 420 employed by the lottery ticket selling system 300 is shown in FIG. 4B.

An example embodiment of a combined printed lottery ticket and printed ticket purchase trailer employed by the lottery ticket selling system 300 is shown in FIG. 4C.

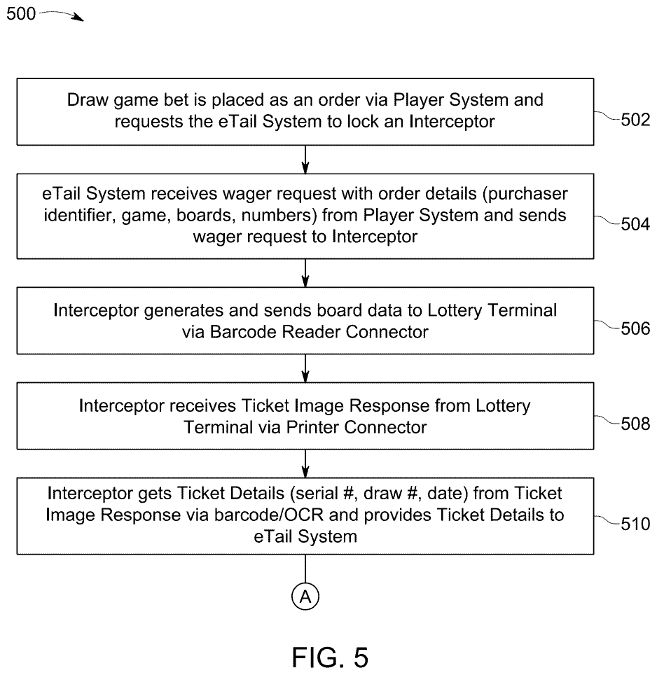

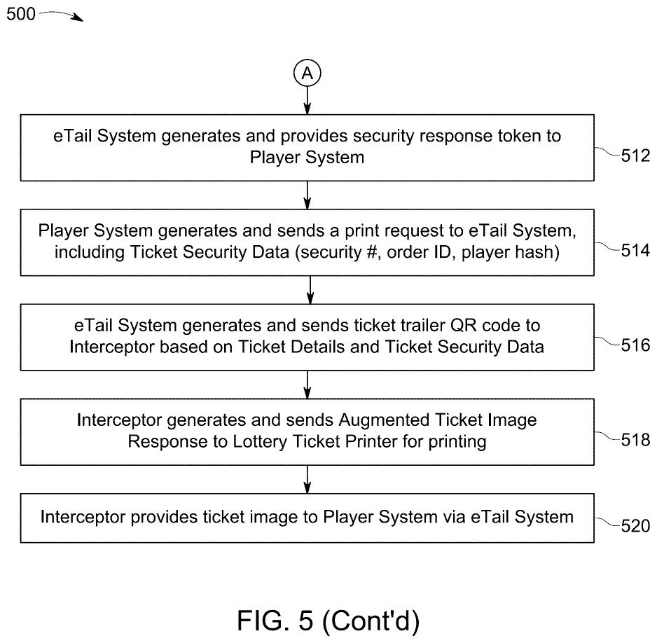

An example method 500 of operating the lottery ticket selling system 300 for a draw lottery ticket purchase by an original purchaser in accordance with one example embodiment of the present disclosure is shown in FIG. 5 and described below.

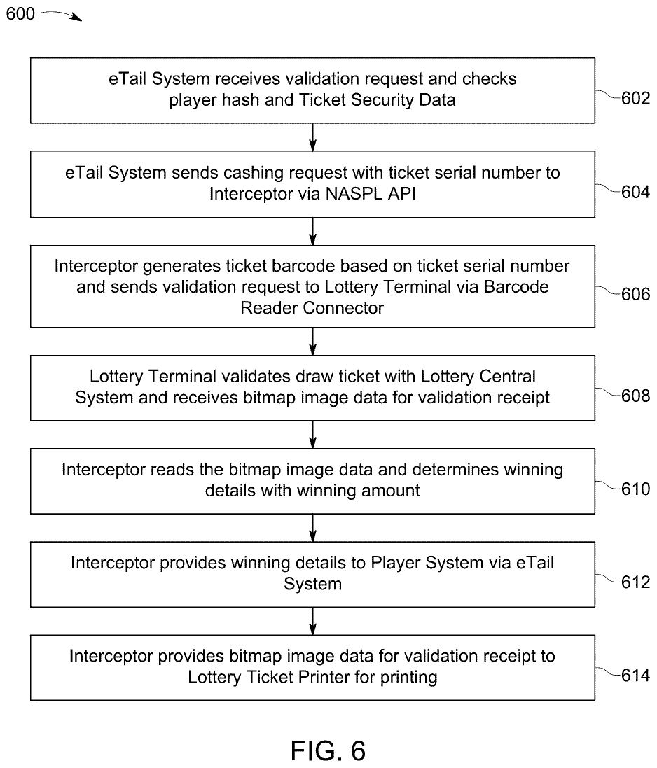

An example method 600 of operating the lottery ticket selling system 300 for a draw lottery ticket redemption by an original purchaser in accordance with one example embodiment of the present disclosure is shown in FIG. 6 and described below.

While these various embodiments of the present disclosure relate to an electronic ticket retail server or courier server (and related systems and methods), the present disclosure can be employed with other suitable servers, system, and methods that are not courier related.

This illustrated example embodiment of the present disclosure provides the lottery ticket selling system 300 including: (a) a player system 310; (b) an electronic ticket retail server 330 (also referred to herein as “eTail system 330”); (c) a terminal interceptor 340; (d) a lottery terminal 360; (e) a lottery ticket printer 380; and (f) a lottery central system 390.

In various embodiments, the lottery ticket selling system 300 includes a ticket tracking system 301 that enables an original purchaser (also sometimes referred to herein as a “player”) to employ the player system 310 to remotely electronically purchase one or more draw lottery tickets for one or more draw lottery games without physically visiting a lottery terminal at a retail location. In various embodiments, the ticket tracking system 301 includes a courier system.

Various embodiments of the present disclosure are directed to the terminal interceptor 340 itself and methods of operation thereof.

Various embodiments of the present disclosure are directed to the eTail system 330 itself and methods of operation thereof.

Various other embodiments of the present disclosure are directed to the eTail system 330 and the terminal interceptor 340 and methods of operation thereof.

Various other embodiments of the present disclosure are directed to the eTail system 330, the terminal interceptor 340, and the lottery ticket printer 380 and methods of operation thereof.

Various other embodiments of the present disclosure are directed to the eTail system 330, the terminal interceptor 340, the lottery terminal 360, and the lottery ticket printer 380 and methods of operation thereof.

Various other embodiments of the present disclosure are directed to the terminal interceptor 340 and the lottery terminal 360 and methods of operation thereof.

Various other embodiments of the present disclosure are directed to the terminal interceptor 340, the lottery terminal 360, and the lottery ticket printer 380 and methods of operation thereof.

In this illustrated example embodiment, the player system 310 and the eTail system 330 are configured to communicate with each other via a suitable data network 320 such as but not limited to a cellular data network or the Internet.

In this illustrated example embodiment, the eTail system 330 and the terminal interceptor 340 are configured to communicate with each other via a suitable data network 322 such as but not limited to a cellular data network or the Internet. In some embodiments, the data network 322 includes a courier router. In other embodiments, the communication between these components can be via hard wire connection such as a USB connector, via wireless connection such as Bluetooth, or other suitable data connection.

In this illustrated example embodiment, the terminal interceptor 340 and the lottery terminal 360 are configured to communicate with each other via hard wires such as an USB connector. In other embodiments, the communication between these components can be via a suitable data network.

In this illustrated example embodiment, the terminal interceptor 340 and the lottery ticket printer 380 are configured to communicate with each other via hard wire such as an USB connector. In other embodiments, the communication between these components can be via a suitable data network.

In this illustrated example embodiment, the lottery terminal 360 is configured to communicate with a lottery ticket printer via hard wire such as an USB connector. In other embodiments, the communication between these components can be via a suitable data network.

In this illustrated example embodiment, the lottery terminal 360 is configured to communicate with a code reader via hard wire such as an USB connector. In other embodiments, the communication between these components can be via a suitable data network.

In this illustrated example embodiment, the lottery ticket printer 380 is configured to communicate with a lottery terminal via hard wire such as an USB connector. In other embodiments, the communication between these components can be via a suitable data network.

In this illustrated example embodiment, the lottery terminal 360 and the lottery central system 390 are configured to communicate with each other via a suitable data network 170 such as a cellular data network, the Internet, or a private secure network. In some embodiments, the data network 170 includes a lottery router that enables communication with a private secure network.

In various embodiments, the player system 310 includes a player electronic device with a mobile application (not shown) downloaded thereon. The player electronic device can include an electronic smartphone, an electronic tablet, an electronic watch, or other suitable electronic computing device with suitable data communication, user input, and display functions. The player system 310 includes a processor (not shown) and a memory device (not shown) that includes instructions that when executed by the processor cause and/or configure the processor to provide functionality as described herein. In various embodiments, the mobile application includes instructions stored in the memory device of the player system 310. In various embodiments, all, or a portion of the functionality of the mobile application can be implemented using application-specific integrated circuits or other suitable hardware. In various embodiments, the mobile application of the player system 310 includes a courier mobile application such as the courier mobile application as described above or any other suitable courier mobile application.

The mobile application of the player system 310 enables a player (e.g., an original purchaser) of the player system 310 to purchase a draw lottery ticket and obtain that purchased draw lottery ticket and/or a ticket purchase trailer for that purchased draw lottery ticket without physically visiting a lottery terminal at a retail location. In various embodiments, the original purchaser obtains the purchased draw lottery ticket as: (a) a printed draw lottery ticket; (b) a digital (or virtual) draw lottery ticket; or (c) both a printed draw lottery ticket and a digital draw lottery ticket. In some embodiments, the lottery ticket selling system 300 causes each purchased draw lottery ticket to be printed, but printed draw lottery tickets are provided to the original purchaser in only certain scenarios, such as when the purchased draw lottery ticket is identified as a winning draw lottery ticket, when the purchased draw lottery ticket has a winning amount over a threshold (e.g., $600 or more), or when requested by the original purchaser. In some embodiments, the original purchaser receives the digital draw lottery ticket at a first time (e.g., via the mobile application after the purchase) and receives the printed draw lottery ticket at a second, later time (e.g., after the printed draw lottery ticket is identified as a winning draw lottery ticket). In some embodiments, the printed draw lottery ticket is stored (e.g., as part of a courier service), but not physically delivered to the original purchaser (e.g., when the printed draw lottery ticket is not a winning ticket, has a winning amount less than $600, etc.).

In various embodiments, lottery ticket selling system 300 enables the original purchaser to obtain the ticket purchase trailer as: (a) a printed ticket purchase trailer; (b) a digital (or virtual) ticket purchase trailer; or (c) both a printed ticket purchase trailer and a digital ticket purchase trailer. In some embodiments, the lottery ticket selling system 300 causes each ticket purchase trailer to be printed, but printed ticket purchase trailer are provided to the original purchaser in only certain scenarios, such as when the purchased draw lottery ticket associated with that ticket purchase trailer is identified as a winning draw lottery ticket, when the purchased draw lottery ticket has a winning amount over a threshold (e.g., $600 or more), or when requested by the original purchaser. In some embodiments, the original purchaser receives the digital ticket purchase trailer at a first time (e.g., via the mobile application after the purchase) and receives the printed ticket purchase trailer at a second, later time (e.g., after the printed draw lottery ticket is identified as a winning draw lottery ticket). In some embodiments, the printed ticket purchase trailer is stored (e.g., as part of a courier service), but not physically delivered to the original purchaser (e.g., when the printed draw lottery ticket is not a winning ticket, has a winning amount less than $600, etc.).

In various embodiments, the mobile application is configured to: (a) enable a player to use the mobile application on the player system 310 to set up a player account with the eTail system 330; (b) deposit funds to the player account; (c) withdraw funds from the player account; (d) use funds in the player account to purchase a draw lottery ticket for a draw lottery game; (e) generate a lottery ticket order (such as a lottery ticket order 370) for the purchase of the draw lottery ticket; (f) cause the player system 310 to send the lottery ticket order to the eTail system 330; (g) view ticket details for the purchased draw lottery ticket; and/or (h) view images of the purchased draw lottery ticket.

In various embodiments, the eTail system 330 includes a processor 332, a memory device 334 including instructions that when executed by the processor 332 cause and/or configure the processor 332 to provide at least the functionality as described herein, a bet slip processor 336, and a trailer processor 338. In various embodiments, the bet slip processor 336 includes instructions stored in the memory device 334. In various embodiments, the trailer processor 338 includes instructions stored in the memory device 334. The processor 332 may be referred to as a “server processor” herein for clarity but is not limited to server processors or server class processors and can include any suitable processor. The memory device 334 may be referred to as a “server memory device” herein for clarity but is not limited to server memory devices or server class memory devices and can include any suitable memory device. In various embodiments, all, or a portion of the functionality of the eTail system 330 can be implemented using application-specific integrated circuits or other suitable hardware. In various embodiments, the eTail system 330 includes a courier server, such as the courier server 130, located at a suitable courier processing center (not shown).

In various embodiments, the eTail system 330 is configured to generate a ticket purchase identifier. In various embodiments, the ticket purchase identifier includes an eTail system identifier and an original purchaser identifier, as described herein. In various embodiments, the ticket purchase identifier is employable to associate a draw lottery ticket (purchased draw lottery ticket or printed draw lottery ticket) with an original purchaser of that draw lottery ticket. The ticket purchase identifier can also or alternatively associate that draw lottery ticket with an original purchaser account that can facilitate identification of that original purchaser. That is, an identity of the original purchaser of the player system 310 is identifiable using the ticket purchase identifier. The eTail system 330 generates the ticket purchase identifier for the draw lottery ticket prior to a purchase of that draw lottery ticket. In various embodiments, the ticket purchase identifier includes other suitable information that is associated with a courier service, such as an order ID associated with the lottery ticket order 370, a bundle ID associated with a bundle of printed draw lottery tickets, and/or a digital fingerprint associated with the original purchaser. In various embodiments, the ticket purchase identifier is independent from data associated with the lottery central system 390.

In various embodiments, the eTail system 330 generates a ticket purchase trailer, such as a ticket purchase trailer 389, that is associated with a draw lottery ticket (purchased draw lottery ticket or printed draw lottery ticket). In various embodiments, the ticket purchase trailer includes: (1) the ticket purchase identifier for that draw lottery ticket; (2) ticket details associated with that draw lottery ticket (e.g., the ticket serial number, the player numbers); and/or other suitable ticket information. In various embodiments, the ticket purchase trailer includes a QR code, a barcode, an image, or information in another suitable format.

Since the ticket purchase trailer includes the ticket details and the ticket purchase identifier, the ticket purchase trailer associates the purchased draw lottery ticket with the original purchaser, who is identifiable from the ticket purchase identifier.

In various embodiments, the eTail system 330 generates the ticket purchase trailer to be: (1) printed on a printed ticket receipt that is separate from the printed draw lottery ticket; (2) printed on a printed ticket receipt that is attached to the printed draw lottery ticket; (3) printed on the printed draw lottery ticket itself; (4) digital image data that is separate from the printed draw lottery ticket; (5) digital image data that is separate from a digital draw lottery ticket; and/or (6) digital image data that is included with a digital draw lottery ticket.

In various embodiments, the ticket purchase identifier includes a field or string of data. In some embodiments, the field includes a first sub-field for the eTail system identifier and a second sub-field for the original purchaser identifier. In some embodiments, different eTail systems employ different lengths of the first and second sub-fields. In various embodiments, the ticket purchase identifier includes other suitable information that is associated with a courier service, such as an order ID associated with the lottery ticket order 370, a bundle ID associated with a bundle of printed draw lottery tickets, and/or a digital fingerprint associated with the original purchaser. In various embodiments, the ticket purchase identifier is independent from data associated with the lottery central system 390.

In various embodiments, the eTail system 330 is configured to: (a) receive a lottery ticket order (such as the lottery ticket order 370) from the player system 310; (b) generate bet slip data (such as bet slip data 372) for a purchase of a draw lottery ticket based on the lottery ticket order; (c) send the bet slip data to the terminal interceptor 340 to enable emulation of a code reader scanning a bet slip that in turn enables the purchase of the draw lottery ticket based on the bet slip data; (d) receive ticket details (such as ticket details 379) for a draw lottery ticket, prior to printing of that draw lottery ticket from the terminal interceptor 340; (e) generate a ticket purchase trailer for the draw lottery ticket; and/or (f) provide the ticket purchase trailer to the terminal interceptor 340 to enable emulation of the lottery terminal 360 that in turn enables the printing of the draw lottery ticket with the ticket details and the ticket purchase trailer. In various embodiments, the eTail system 330 generates the ticket purchase trailer to include the ticket purchase identifier, but the bet slip data does not include the ticket purchase identifier.

In various embodiments, the eTail system 330 is configured to enable a courier service, for example, to deposit funds to a player account, to withdraw funds from the player account, and to use funds in the player account to purchase a draw lottery ticket for a lottery game.

In various embodiments, the eTail system 330 can randomly select player numbers for a draw lottery ticket responsive to a quick pick indication by the player.

The terminal interceptor 340 includes a housing 341, a processor 342 supported by the housing 341, a memory device 344 supported by the housing 341, an eTail interface 345, a betslip reader emulator 346, a printer emulator 347, a lottery terminal emulator 348, and a plurality of connectors 349. The memory device 344 includes instructions that when executed by the processor 342 cause and/or configure the processor 342 to provide functionality as described herein. In various embodiments, the eTail interface 345, the betslip reader emulator 346, the printer emulator 347, and/or the lottery terminal emulator 348 include instructions stored in the memory device 334. The processor 342 may be referred to as an “interceptor processor” herein for clarity but is not limited to such processors and can include any suitable processor. The memory device 344 may be referred to as an “interceptor memory device” herein for clarity but is not limited to such memory devices and can include any suitable memory device. In various embodiments, all, or a portion of the functionality of the terminal interceptor 340 can be implemented using application-specific integrated circuits or other suitable hardware.

In various embodiments, the eTail interface 345 enables communication between the terminal interceptor 340 and the eTail system 330, as described herein.

In this illustrated example embodiment, the betslip reader emulator 346 and the lottery terminal 360 are configured to communicate with each other via a hard wire such as via a USB connector (e.g., a connector 349a). In other embodiments, the communication between these components can be via a suitable data network.

In various embodiments, the betslip reader emulator 346 emulates a quick response (QR) code reader, a barcode reader, an image capture device, CIS reader, or other suitable reader. In this embodiment, the betslip reader emulator 346 emulates the code reader 165. The betslip reader emulator 346 can be any suitable device that is capable of receiving the bet slip data 372 from the eTail system 330 and processing the bet slip data for a selected play of a selected draw lottery game from the eTail system 330 to create bet slip scan data 373 in a format that is acceptable for processing by the lottery terminal 360. In various embodiments, this bet slip scan data is in an identical (or substantially identical) format as the code reader 165 provides the lottery terminal 360 as discussed above. Thus, various embodiments of the present disclosure contemplate minimal changes to the known lottery terminal 160 to form the lottery terminal 360.

In various embodiments, the betslip reader emulator 346 communicates with a betslip reader device driver (not shown) of the lottery terminal 360. In various other embodiments, the betslip reader emulator 346 bypasses betslip reader hardware of the lottery terminal 360 and directly communicates with a terminal application (not shown) of the lottery terminal 360. In certain embodiments, the betslip reader hardware of the lottery terminal 360 can be disconnected.

In this illustrated example embodiment, the printer emulator 347 and the lottery terminal 360 are configured to communicate with each other via a hard wire such as via a USB connector (e.g., connector 349b). In other embodiments, the communication between these components can be via a suitable data network.

In various embodiments, the printer emulator 347 emulates the lottery ticket printer 380. The printer emulator 347 can be any suitable device that is capable of receiving a ticket image response 382 from the lottery terminal 360 for printing a draw lottery ticket and processing the ticket image response 382 to obtain ticket details 379. In various embodiments, the printer emulator 347 provides a confirmation (not shown) of receiving and/or printing the ticket image response 382 and/or other suitable information to the lottery terminal 360 in an identical (or substantially identical) format as the lottery ticket printer 380 provides the lottery terminal 360 as discussed above. Thus, various embodiments of the present disclosure contemplate minimal changes to the known lottery terminal 160 to form the lottery terminal 360.

In various embodiments, the printer emulator 347 communicates with a lottery ticket printer device driver (not shown) of the lottery terminal 360. In various other embodiments, the printer emulator 347 bypasses lottery ticket printer hardware of the lottery terminal 360 and directly communicates with a terminal application (not shown) of the lottery terminal 360. In certain embodiments, the lottery ticket printer hardware of the lottery terminal 360 can be disconnected.

In this illustrated example embodiment, the terminal emulator 348 and the lottery ticket printer 380 are configured to communicate with each other via a hard wire such as via a USB connector (e.g., connector 349c). In other embodiments, the communication between these components can be via a suitable data network.

In various embodiments, the terminal emulator 348 emulates the lottery terminal 360. In some such embodiments, the terminal emulator 348 emulates a motherboard 362 of the lottery terminal 360. In various embodiments, the terminal emulator 348 communicates with a lottery terminal interface (not shown) of the lottery ticket printer 380. The terminal emulator 348 can be any suitable device that is capable of sending a ticket image response (e.g., an augmented ticket image response 388) to the lottery ticket printer 380 for printing a draw lottery ticket. Thus, various embodiments of the present disclosure contemplate minimal changes to the known lottery ticket printer 180 to form the lottery ticket printer 380.

In various embodiments, the plurality of connectors 349 include different connectors (e.g., USB connectors, external serial ATA (eSATA) connectors, or other suitable data connectors) that enable communication with a lottery terminal (such as the lottery terminal 360) and a lottery ticket printer (such as the lottery ticket printer 380). In this example embodiment, the plurality of connectors include a terminal code reader connector 349a (“barcode reader connector”), a terminal printer connector 349b (“printer connector”), and a printer terminal connector 349c. In various embodiments, the plurality of connectors 349 are configured to receive a communication cable that is operable to enable communication with a particular lottery terminal, any of a class or group of lottery terminals, a particular lottery ticket printer, any of a class or group of lottery ticket printers, or other suitable devices.

In various embodiments, the terminal interceptor 340 is configured to enable communication with a plurality of lottery terminals (such as multiple instances of the lottery terminal 360). In some such embodiments, the plurality of connectors 349 includes one connector 349a and one connector 349b for each such lottery terminal. In some such embodiments, the terminal interceptor 340 includes one betslip reader emulator 346 and one printer emulator 347 for each such lottery terminal.

In various embodiments, the terminal interceptor 340 is configured to enable communication with a plurality of lottery ticket printers (such as multiple instances of the lottery ticket printer 380). In some such embodiments, the plurality of connectors 349 includes one connector 349c for each such lottery ticket printer. In some such embodiments, the terminal interceptor 340 includes one terminal emulator 348 for each such lottery ticket printer.

The lottery terminal 360 includes a motherboard 362, a processor (not shown), and a memory device (not shown). The memory device includes instructions that when executed by the processor cause and/or configure the processor to provide functionality as described herein. The processor of the lottery terminal 360 may be referred to as a “terminal processor” herein for clarity but is not limited to terminal processors or terminal class processors and can include any suitable processor. The memory device of the lottery terminal 360 may be referred to as a “terminal memory device” herein for clarity but is not limited to terminal memory devices or terminal class memory devices and can include any suitable memory device.

The motherboard 362 (or another suitable component of the lottery terminal 360) includes a plurality of connectors (not shown) that enable communication with a code reader and a lottery terminal printer, such as a code reader connector that is connectable to a code reader (e.g., code reader 165) and a printer connector that is connectable to a lottery ticket printer (e.g., lottery ticket printer 180). In various embodiments, the motherboard 362 stores, hosts, and/or executes a betslip reader device driver that enables communication with a code reader via the code reader connector. In various embodiments, the motherboard 362 stores, hosts, and/or executes a lottery ticket printer device driver that enables communication with a lottery ticket printer via the printer connector.

In this example embodiment, the code reader connector of the lottery terminal 360 is connected with the terminal code reader connector 349a of the terminal interceptor 340 instead of to a code reader. In this configuration, the terminal interceptor 340 is enabled to emulate the code reader and provide bet slip scan data to the lottery terminal 160 in place of any bet slip scan data that would normally be communicated to the lottery terminal 160 by the code reader 165 (e.g., from scanning a bet slip).

In this example embodiment, the printer connector of the lottery terminal 360 is connected with the terminal printer connector 349b of the terminal interceptor 340 instead of to a lottery ticket printer. In this configuration, the terminal interceptor 340 is enabled to emulate the lottery ticket printer 180 and receive a ticket image response that would normally be communicated to the lottery ticket printer 180 by the lottery terminal 160.

In various embodiments, the lottery terminal 360 is configured to: (a) receive bet slip scan data (such as the bet slip scan data 373); (b) generate a bet request (such as a bet request 374) based on the bet slip scan data; (c) send the bet request to the lottery central system 390 to cause a purchase of a draw lottery ticket based on the bet slip scan data; (d) receive a bet response from the lottery central system 390 (such as a bet response 376); and/or (e) cause the lottery ticket printer 380 to print the purchased draw lottery ticket (such as the printed draw lottery ticket 378 and/or 410) based on the bet response.

In various embodiments, the lottery terminal 360 generates and provides a lottery ticket printing request to cause the purchased draw lottery ticket to be printed. In various embodiments, the lottery ticket printing request includes a ticket image response (such as ticket image response 382) for the purchased draw lottery ticket. In various embodiments, the ticket image response includes ticket digital image data and/or ticket details for the purchased draw lottery ticket. The ticket details can include a ticket identifier and/or serial number, an indication of the draw lottery game, the date of the play of the draw lottery game that the draw lottery ticket relates to, and the player numbers for the play of the draw lottery game.

The lottery ticket printer 380 includes: (a) a printer housing 381a; (b) a supply paper holder 381b supported by the printer housing 381a; (c) a plurality of roll engagers (not shown) supported by the printer housing 381a; (d) a terminal connector (not shown) that is connectable to a lottery terminal (e.g., via a printer connector of the lottery terminal 360); and (e) a controller (not shown) supported by the printer housing 381a. The lottery ticket printer 380 is configured to print draw lottery tickets, such as a printed draw lottery ticket 378. In various embodiments, the lottery ticket printer 380 receives a lottery ticket printing request (or lottery ticket image) associated with a draw lottery ticket and prints that draw lottery ticket.

The lottery central system 390 includes a processor (not shown) and a memory device (not shown). The memory device includes instructions that when executed by the processor cause and/or configure the processor to provide functionality as described herein. In various embodiments, the lottery central system 390 includes a server or other suitable computing device. In various embodiments, all, or a portion of the functionality of the lottery central system 390 can be implemented using application-specific integrated circuits or other suitable hardware.

In various embodiments, the lottery central system 390 is configured to: (a) receive a bet request (such as the bet request 374) for the purchase of a draw lottery ticket from the lottery terminal 360; (b) obtain bet details for the purchase from the bet request; (c) randomly select draw numbers for the bet request (e.g., for a quick pick indication); (d) generate a bet for the purchase of a draw lottery ticket based on the bet details; (e) log (such as store) the bet; (f) generate and send a bet response (such as the bet response 376) for the bet request to the lottery terminal 360; (g) process lottery ticket redemption requests for draw lottery tickets; and/or (h) other lottery ticket related functionality.

In various embodiments, the eTail system 330 and/or the ticket tracking system 301 enable purchase of a draw lottery ticket and generation of the ticket purchase trailer without modification to the lottery terminal 160, the lottery ticket printer 180, and/or the lottery central system 200. In other words, the lottery terminal 360, the lottery ticket printer 380, and/or the lottery central system 390 as employed by the lottery ticket selling system 300 are not modified from known systems (e.g., the lottery terminal 160, the lottery ticket printer 180, the lottery central system 200), such as the courier system 100.

Referring to FIG. 4A, an example embodiment of a printed draw lottery ticket 410 employed by the lottery ticket selling system 300 is shown. In various embodiments, the printed draw lottery ticket 410 includes ticket details 412 for a purchased draw lottery ticket (shown as “Draw Ticket”) and a ticket purchase trailer 414 for the purchased draw lottery ticket 410, which are printed on a same ticket substrate 411. In various embodiments, the ticket details 412 include one or more features of the physical draw lottery ticket 10, such as the player numbers 16, the ticket identifier 18, the game identifier 20, the draw date 22, the print date 24, and/or the ticket barcode 26. In various embodiments, the lottery ticket printer 380 prints the ticket purchase trailer 414 on a front surface and/or a rear surface of the ticket substrate 411.

In various embodiments, one or more of the ticket details 412, the ticket purchase trailer 414, and/or other suitable information have a human readable format on the printed draw lottery ticket 410, such as a text format or image format. In various embodiments, one or more of the ticket details 412, the ticket purchase trailer 414, and/or other suitable information have a format that is not readily human readable, such as an encoded format (e.g., a barcode or QR code) or encrypted format. In various embodiments, the printed draw lottery ticket 410 includes at least some information in a human readable format and at least some information in a format that is not readily human readable. In some such embodiments, the printed draw lottery ticket 410 includes at least some information in both a human readable format and a format that is not readily human readable (e.g., a ticket serial number provided as plain text and as a barcode).

In this example embodiment, the ticket purchase trailer 414 includes a QR code printed on the printed draw lottery ticket 410. In various embodiments, the ticket purchase trailer 414 includes the ticket purchase identifier. In various embodiments, the ticket purchase trailer 414 includes the ticket purchase identifier, the ticket details for the printed draw lottery ticket 410, and/or other suitable information. In various embodiments, the ticket purchase trailer 414 includes data that is different from the bet slip data 372 and/or the bet slip scan data 373. In some such embodiments, the ticket purchase trailer 414 includes the ticket serial number (e.g., ticket identifier 18) or other suitable information that was not included in the bet slip data 372 and/or the bet slip scan data 373. In some such embodiments, the ticket purchase trailer 414 includes information that was not yet generated by the lottery central system 390 or was unavailable to the eTail system 330 when the bet slip data 372 was generated by the eTail system 330.

Referring to FIG. 4B, an example embodiment of a printed draw lottery ticket 410 and a printed ticket receipt 420 employed by the lottery ticket selling system 300 is shown. As described above, the printed draw lottery ticket 410 includes the ticket details 412 (shown as “Draw Ticket”) printed on a ticket substrate 411 by the lottery ticket printer 380. In this example embodiment, the lottery ticket printer 380 prints the printed ticket receipt 420 to include the ticket purchase trailer 414 on a receipt substrate 421 that is separate from the ticket substrate 411. In some embodiments, the printed ticket receipt 420 also includes all or a portion of the ticket details 412 and/or other suitable information on a front surface and/or a rear surface of the receipt substrate 421.

Referring to FIG. 4C, an example embodiment of a printed draw lottery ticket 430 employed by the lottery ticket selling system 300 is shown. In various embodiments, the printed draw lottery ticket 430 includes the ticket details 412 (shown as “Draw Ticket”) and the ticket purchase trailer 414 (e.g., a “combined draw lottery ticket and trailer”). In various embodiments, the lottery ticket printer 380 prints the printed draw lottery ticket 430 on an enlarged ticket substrate 431 that is physically larger than the ticket substrate 12 (FIG. 1) and/or the ticket substrate 411 (FIG. 4B).

In various embodiments, the enlarged ticket substrate 431 includes a ticket region 432 in which the ticket details 412 are printed and a separate receipt region 434 in which the ticket purchase trailer 414 is printed. In some embodiments, the enlarged ticket substrate 431 includes a perforated strip 436, between the ticket region 432 and the receipt region 434, that enables the receipt region 434 to be separated (e.g., torn) from the ticket region 432.

Referring now to FIG. 3B and FIG. 5, an example method 500 of purchasing a draw lottery ticket using the lottery ticket selling system 300 is now described. Although the method is described with reference to the flowchart shown in FIG. 5, other methods of performing the acts associated with this illustrated process may be employed. For example, the order of certain of the illustrated blocks may be changed, certain of the illustrated blocks may be optional, or certain of the illustrated blocks may not be employed.

In this example system and method for purchasing a draw lottery ticket, a draw game bet is placed with the eTail system 330 as a lottery ticket order 370 via the player system 310, as indicated at block 502. In various embodiments, the lottery ticket order 370 includes a request to assign, reserve, and/or lock a terminal interceptor (such as the terminal interceptor 340) for the purchase of the draw lottery ticket. In various embodiments, the mobile application of the player system 310 enables a player (i.e., an original purchaser) to input the player's selected numbers or a quick pick indication for a draw lottery ticket for a draw lottery game that the player wishes to purchase and thus play (such as by interacting with a graphical user interface, scanning a new or previously used bet slip or draw lottery ticket, scanning a ticket purchase trailer from another purchased draw lottery ticket, or identifying a previously purchased draw lottery ticket with player numbers for repurchase).

In various embodiments, the player system 310 generates the lottery ticket order 370 as a wager request that includes bet details (e.g., order details) for the purchase of the draw lottery ticket. The bet details can include a requested draw game identifier that identifies a lottery game type, a requested draw date (e.g., the “boards” to be played), the player selected numbers, player numbers selected by the player system 310, and/or the quick pick indication. The player system 310 sends the lottery ticket order 370 to the eTail system 330 via the data network 320 (FIG. 3A).

In various embodiments and/or scenarios, the mobile application generates the lottery ticket order request to include: (1) ticket information for a single draw lottery ticket; (2) ticket information for multiple draw lottery tickets for a same lottery game and for a same player; and/or (3) ticket information for multiple draw lottery tickets for different lottery games for a same player. In other words, the lottery ticket order request can be associated with one, two, three, or more draw lottery tickets for one, two, three or more draw lottery games.

The eTail system 330 receives the lottery ticket order 370 from the player system 310 and generates bet slip data 372 to include the bet details, as indicated at block 504. The bet slip data 372 is employable by the terminal interceptor 340 to generate bet slip scan data 373 and thereby cause a purchase of a draw lottery ticket based on the bet details. In various embodiments, the eTail system 330 employs the bet details from the lottery ticket order 370 to generate the bet slip data 372. In some embodiments, the eTail system 330 randomly generates player numbers for the digital bet slip, for example, based on a quick pick indication within the lottery ticket order 370.

In various embodiments, the eTail system 330 generates a ticket purchase identifier prior to the purchase of the draw lottery ticket, which enables tracking of the purchased draw lottery ticket and/or association of the purchased draw lottery ticket with the original purchaser (or original purchaser account). In some embodiments, the ticket purchase identifier enables a complete mapping of the purchase, including a lottery ticket order, a bet slip, a bet request, a stored bet for purchased draw lottery ticket, a bet response, and a printed draw lottery ticket

In various embodiments, the eTail system 330 generates the bet slip data 372 to include a QR code. In such embodiments, the eTail system 330 encodes the bet details and/or other suitable ticket information into the QR code. In various embodiments, the QR code improves the speed at which the bet details can be processed by the lottery terminal 360, for example, by providing a data structure from which the bet details can be processed, instead of multiple distinct data structures for each field of the bet details (i.e., a player number region, a game type region, a draw date region, etc.). In some embodiments, the QR code enables error detection and/or error correction when scanning the bet details.

In various embodiments, the ticket purchase identifier includes an eTail system identifier associated with an operator of the eTail system 330 and/or an original purchaser identifier associated with the original purchaser. The eTail system identifier enables identification of the operator of the eTail system 330 through which the bet slip data 372 was received. The original purchaser identifier enables identification of the original purchaser and/or original purchaser account. In various embodiments, the eTail system 330 provides a courier service with a player account for the original purchaser and the ticket purchase identifier is referred to herein as a “courier string”. In various embodiments, different eTail systems employ different courier strings.

In various embodiments, the original purchaser identifier includes an original purchaser digital signature, such as a data structure, data file, data bit sequence, data token, or other suitable digital identifier, that does not by itself uniquely identify the original purchaser, but can be used to uniquely identify the original purchaser using a suitable cryptographic function. In various embodiments, the cryptographic function includes a hash function, a keyed hash function, an encryption function, a decryption function, or other suitable cryptographic function. In various embodiments, the eTail system 330 (or another suitable entity) employs original purchaser identifying information as a parameter or input to the cryptographic function to generate the original purchaser identifier. In some such embodiments, the original purchaser identifier is not readily human readable. In some other embodiments, the original purchaser identifier includes a human readable identifier that uniquely identifies the original purchaser (i.e., without the use of the cryptographic function).

In various embodiments, the original purchaser identifier includes a hash string based on the original purchaser identifying information. In such embodiments, identification and/or verification of the original purchaser is performed by the original purchaser providing the original purchaser identifying information to regenerate the original purchaser identifier (e.g., when redeeming a winning draw lottery ticket). In various embodiments, the original purchaser identifier includes encrypted data, such as an encrypted copy of the original purchaser identifying information (or other suitable data) generated using an encryption key (such as a public key). In such embodiments, the identification and/or verification of the original purchaser is performed by the original purchaser providing a decryption key (such as a private key) associated with the original purchaser to enable decryption of the encrypted data.

In various embodiments, original purchaser identifying information can include, for example: (1) the original purchaser's full name, residential address, and phone number; (2) Government-issued ID number (e.g., social security number, license number, passport number, tax identifier); (3) a biometric and/or physical identifier (e.g., thumbprint); (4) a suitable account number (e.g., bank account number, utility account number); (5) a group ID number or identifier; (6) a group member identifier; (7) the answers to ‘challenge’ questions, such as the player's first pet, where the player was born, etc. ; and/or (8) or other suitable personal identifying information (PII).

In various embodiments, for example, the original purchaser provides their tax identifier and a challenge question answer to the eTail system 330 for generation of the original purchaser identifier as a hash of the tax identifier and the challenge question answer. In such embodiments, the original purchaser provides the same tax identifier and challenge question answer when redeeming a winning draw lottery ticket to re-generate the original purchaser identifier and authenticate the original purchaser.

After its generation, the eTail system 330 sends the bet slip data 372 to the terminal interceptor 340.

The terminal interceptor 340 receives the bet slip data 372 and provides bet slip scan data 373 to the lottery terminal 360 via the connector 349a, as indicated at block 506. The betslip reader emulator 346 generates the bet slip scan data 373 based on the bet slip data 372. In various embodiments, the betslip reader emulator 346 sends the bet slip scan data 373 to the lottery terminal 360 via the connector 349a by emulating the code reader 165. In various embodiments, the betslip reader emulator 346 generates the bet slip scan data 373 to include a QR code, including board data for the draw lottery ticket (e.g., the bet details).

In various embodiments, the lottery terminal 360 generates a bet request 374 for the purchase of the draw lottery ticket and the bet request 374 includes the bet details based on the bet slip scan data 373. The lottery terminal 360 sends the bet request 374 to the lottery central system 390 via the data network 170 (FIG. 2) to cause the purchase of the draw lottery ticket based on the bet slip scan data.

In various embodiments, the lottery central system 390 receives the bet request 374, generates a bet based on the bet details of the bet request 374, and logs the bet in the lottery central system 390. The generated bet includes ticket details 379 for the purchased draw lottery ticket, such as a ticket serial number (e.g., ticket identifier 18), player numbers, a security code that facilitates authentication of the purchased draw lottery ticket, and/or other suitable ticket information.

In this example embodiment, the bet, bet details, and/or ticket details do not include the ticket purchase identifier generated by the eTail system 330 (e.g., the ticket purchase identifier is independent from the bet, bet details, and/or ticket details). In various embodiments, a valid draw lottery ticket includes only ticket details, such as when purchased from the courier server 130 or lottery terminal 160.

After creation of the bet, the lottery central system 390 generates and provides a bet response 376 to the lottery terminal 360. In various embodiments, the bet response 376 includes a confirmation of the purchase of the draw lottery ticket and/or other suitable ticket information. In various embodiments, the confirmation includes the ticket details 379 for the purchased draw lottery ticket, such as the ticket serial number, the player numbers, and/or the security code.

The lottery terminal 360 obtains the ticket details 379 from the bet response 376 and generates a ticket image response 382 that includes the ticket details 379 for the purchased draw lottery ticket. As described above, the ticket image response 382 includes ticket digital image data for the purchased draw lottery ticket.

The terminal interceptor 340 receives the ticket image response 382 from the lottery terminal 360 via the connector 349b, as indicated at block 508. In various embodiments, the printer emulator 347 receives the ticket image response by emulating the lottery ticket printer 380. In some embodiments, the terminal interceptor 340 provides a confirmation of the receipt to the lottery terminal 360. In some embodiments, the terminal interceptor 340 provides a confirmation of printing of the purchased draw lottery ticket to the lottery terminal 360.

The terminal interceptor 340 obtains the ticket details 379 for the purchased draw lottery ticket from the ticket image response 382 and sends the ticket details 379 to the eTail system 330, as indicated at block 510. In various embodiments, the terminal interceptor 340 employs an optical character recognition function and/or barcode reader function to obtain the ticket details 379 from the ticket image response 382.

The eTail system 330 receives the ticket details 379 from the terminal interceptor 340 and provides the ticket details 379 to the player system 310, as indicated at block 512. As described above, the ticket details 379 include the ticket serial number (e.g., ticket identifier 18), the player numbers, the security code that facilitates authentication of the purchased draw lottery ticket, and/or other suitable ticket information. In various embodiments, the eTail system 330 stores the ticket details 379, for example, to authenticate any future validation requests for the purchased draw lottery ticket, as described below.

In various embodiments, the eTail system 330 employs the ticket details 379 to confirm the bet details and the ticket details. The eTail system 330 compares the ticket details 379 with the bet details from the bet slip data 372 to ensure that the purchased draw lottery ticket 378 matches the lottery ticket order 370 of the original purchaser (i.e., matching player numbers, matching draw date, etc.). In other words, the eTail system 330 validates that the lottery ticket order 370 has been properly fulfilled.

The player system 310 generates and sends a print request (not shown) to the eTail system 330, as indicated at block 514. In various embodiments, the print request includes ticket security data, such as the security code from the ticket details 379, an order identifier associated with the lottery ticket order 370, an original purchaser identifier associated with the original purchaser (e.g., a hash of the original purchaser identifying information), and/or other suitable information.

The eTail system 330 generates and sends a ticket purchase trailer 386 to the terminal interceptor 340 based on the print request received from the player system 310 and the ticket details 379, as indicated at block 516. As described above, the ticket purchase trailer 386 can include a QR code, a barcode, an image, or information in another suitable format. In various embodiments, the eTail system 330 generates the ticket purchase trailer 386 to include digital image data (referred to herein as “trailer digital image data”) or a “trailer digital image” that comprises the ticket purchase trailer.

As described above, the ticket purchase trailer 386 includes the ticket purchase identifier and thereby includes the original purchaser identifier associated with the original purchaser. In some embodiments, the eTail system 330 generates the ticket purchase identifier prior to the purchase of the draw lottery ticket. In some embodiments, the eTail system 330 generates the ticket purchase identifier after the purchase of the draw lottery ticket. In some embodiments, the eTail system 330 generates the ticket purchase identifier after receipt of the print request from the player system 310.

The terminal interceptor 340 generates and sends an augmented ticket image response 388 to the lottery ticket printer 380 to cause the lottery ticket printer 380 to print the printed draw lottery ticket 378, as indicated at block 518. In various embodiments, the lottery terminal emulator 348 sends the augmented ticket image response 388 to the lottery ticket printer 380 via the connector 349c by emulating the lottery terminal 360. The printed draw lottery ticket 378 includes the ticket details from the ticket image response 382, shown as ticket details 379 (“Draw Ticket”), and the ticket purchase trailer 386.

In various embodiments, the terminal interceptor 340 generates the augmented ticket image response 388 to include the ticket details 379 separately from the ticket purchase trailer 386. In some such embodiments, the augmented ticket image response 388 includes a first portion that is similar to the printed draw lottery ticket 410 shown in FIG. 4B and a second portion that is similar to the printed ticket receipt 420 shown in FIG. 4B. In some such embodiments, the first portion includes the ticket digital image data from the ticket image response 382 and the second portion includes the ticket purchase trailer 386.

In various embodiments, the terminal interceptor 340 generates the augmented ticket image response 388 to include the ticket purchase trailer 386 appended to the ticket details 379 (e.g., appended to the ticket digital image data from the ticket image response 382). In some such embodiments, the augmented ticket image response 388 comprises a single image (e.g., a combined ticket and trailer image) that includes the ticket details 379 and the ticket purchase trailer 386 appended thereto (or otherwise suitable combined) without modifying the ticket digital image data. In some such embodiments, the combined ticket and trailer image has a different pixel aspect ratio from the ticket digital image data. As one example where the ticket digital image data has a pixel size of 100×200 pixels (aspect ratio 1:2) and the trailer digital image data has a pixel size of 100×30 pixels, the combined ticket and trailer image has a pixel size of 100×230 pixels (aspect ratio 1:2.3). As another example where the ticket digital image data has a pixel size of 100×200 pixels (aspect ratio 1:2) and the trailer digital image data has a pixel size of 40×200 pixels, the combined ticket and trailer image has a pixel size of 140×200 pixels (aspect ratio 1:1.43). In some such embodiments, the combined ticket and trailer image is similar to the printed draw lottery ticket 430 shown in FIG. 4C.

In various embodiments, the eTail system 330 generates the ticket purchase trailer 386 to be stored and/or written over a portion of the ticket digital image data from the ticket image response 382. In some such embodiments, the terminal interceptor 340 generates the augmented ticket image response 388 (e.g., an augmented ticket and trailer image) by modifying the ticket digital image data to include the ticket purchase trailer 386 without changing a pixel aspect ratio of the ticket digital image data and/or changing a pixel size of the ticket digital image data. As one example where the ticket digital image data has a pixel size of 100×200 pixels (aspect ratio 1:2) and the ticket purchase trailer 386 has a pixel size of 100×30 pixels, the augmented ticket and trailer image has a pixel size of 100×200 pixels (aspect ratio 1:2). In some such embodiments, the augmented ticket and trailer image is similar to the printed draw lottery ticket 410 shown in FIG. 4A.

As described above, the lottery ticket printer 380 prints the ticket purchase trailer: (1) on a printed ticket receipt that is separate from the printed draw lottery ticket (e.g., FIG. 4B); (2) on a printed ticket receipt that is attached to the printed draw lottery ticket (e.g., FIG. 4C; and/or (3) on the printed draw lottery ticket itself (e.g., FIG. 4A).

The terminal interceptor 340 provides a ticket image for the printed draw lottery ticket 378 to the player system 310 via the eTail system 330, as indicated at block 520. In some embodiments, the terminal interceptor 340 sends the augmented ticket image response 388 to the player system 310. In some embodiments, the terminal interceptor 340 processes and/or converts the augmented ticket image response 388 into a draw lottery ticket image and provides the draw lottery ticket image to the player system 310.

Referring now to FIG. 3B and FIG. 6, an example method 600 of redeeming a draw lottery ticket using the lottery ticket selling system 300 is now described. Although the method is described with reference to the flowchart shown in FIG. 6, other methods of performing the acts associated with this illustrated process may be employed. For example, the order of certain of the illustrated blocks may be changed, certain of the illustrated blocks may be optional, or certain of the illustrated blocks may not be employed.

In this example system and method for redeeming a draw lottery ticket, the eTail system 330 receives a validation request (not shown) from the player system 310, as indicated at block 602. In various embodiments, the validation request includes ticket security data for a purchased draw lottery ticket, such as the security code from the ticket details 379, an order identifier associated with the lottery ticket order 370 for that purchased draw lottery ticket, a ticket serial number, an original purchaser identifier associated with the original purchaser (e.g., player hash), and/or other suitable information.

In various embodiments, the eTail system 330 checks the player hash and the ticket security data to authenticate the validation request. In some embodiments, the eTail system 330 verifies that the player hash and ticket security data match previously stored ticket details for that purchased draw lottery ticket and proceeds only when the player system 310 from which the validation request is received is associated with the original purchaser of the purchased draw lottery ticket.

The eTail system 330 sends a cashing request that includes the ticket serial number to the terminal interceptor 340, as indicated at block 604. In some embodiments, the eTail system 330 employs a suitable application programming interface (API) to send the cashing request to the terminal interceptor 340, such as a North American Association of State and Provincial Lotteries (NASPL) API.

The terminal interceptor 340 generates and sends ticket barcode scan data based on the ticket serial number to the lottery terminal 360 via the connector 349a to cause the lottery terminal 360 to generate a validation receipt, as indicated at block 606. The ticket barcode scan data includes the security code for the purchased draw lottery ticket.

Based on the security code, the lottery terminal 360 validates the purchased draw lottery ticket with the lottery central system 390 and receives a validation image response for printing a validation receipt, as indicated at block 608. The validation image response includes validation digital image data for the validation receipt, such as bitmap image data. The validation image response includes winning ticket details with any winning amount. The lottery terminal 360 sends the validation image response to the terminal interceptor 340.

The terminal interceptor 340 obtains the winning ticket details from the validation image response, as indicated at block 610. In various embodiments, the terminal interceptor 340 employs an optical character recognition function to obtain the winning ticket details from the validation image response.

The terminal interceptor 340 provides the winning details to the player system 310 via the eTail system 330, as indicated at block 612.

The terminal interceptor 340 provides the validation image response to the lottery ticket printer 380 for printing of the validation receipt, as indicated at block 614.

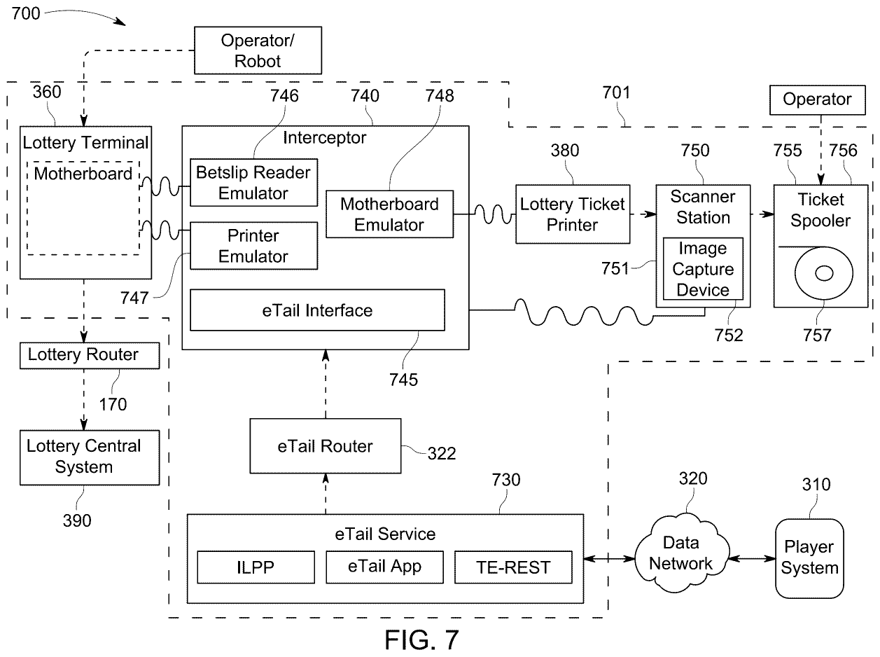

Turning to FIG. 7, an example lottery ticket selling system 700 in accordance with one example embodiment of the present disclosure is shown. This illustrated example embodiment of the present disclosure provides the lottery ticket selling system 700 including: (a) a player system 310; (b) an electronic ticket retail server 730 (also referred to herein as “eTail system 730”); (c) a terminal interceptor 740; (d) a lottery terminal 360; (e) a lottery ticket printer 380; (f) a lottery central system 390; (g) a scanner station 750; and/or (h) a ticket spooler 755. In various embodiments, the lottery ticket selling system 700 includes a ticket tracking system 701 that enables an original purchaser (also sometimes referred to herein as a “player”) to employ the player system 310 to remotely electronically purchase one or more draw lottery tickets for one or more draw lottery games without physically visiting a lottery terminal at a retail location. In various embodiments, the ticket tracking system 701 includes a courier system.

For this illustrated example embodiment, the configuration, and functions of the player system 310, the lottery terminal 360, and the lottery central system 390 do not need to change from the configuration and functions described above with respect to FIGS. 3A and 3B, and are thus not described herein for brevity.

For this illustrated example embodiment, the lottery ticket printer 380 includes the configuration and functions of the lottery ticket printer 380 described above, with additional functionality as described herein. In some embodiments, the lottery ticket printer 380 is configured to disable a ticket cutting and/or ticket separation function such that printed draw lottery tickets are printed as a printed lottery ticket roll. In some embodiments, the lottery ticket printer 380 is configured to receive instructions that temporary disable a ticket cutting and/or ticket separation function such that printed draw lottery tickets are printed as a printed lottery ticket roll while the ticket cutting and/or ticket separation function is temporarily disabled.

For this illustrated example embodiment, the eTail system 730 includes the configuration and functions of the eTail system 330, with additional functionality as described herein.

For this illustrated example embodiment, the terminal interceptor 740 includes the configuration and functions of the terminal interceptor 340, with additional functionality as described herein.

In this illustrated example embodiment, the terminal interceptor 740 is configured to communicate with a scanner station 750 via hard wire such as an USB connector. In other embodiments, the communication between these components can be via a suitable data network.

In various embodiments, the terminal interceptor 740 is configured to generate and provide lottery ticket printing requests to the lottery ticket printer 380 to cause the lottery ticket printer 380 to print multiple draw lottery tickets as a printed lottery ticket roll (e.g., draw lottery tickets that have not been cut or separated from each other). In some embodiments, the terminal interceptor 740 provides a lottery ticket printing request that includes a ticket image response (such as the augmented ticket image response 388) and instructions for the lottery ticket printer 380 to disable the ticket cutting and/or separation function. In such embodiments, the lottery ticket printer 380 prints a draw lottery ticket but does not cut that printed draw lottery ticket such that a subsequent draw lottery ticket printed by the lottery ticket printer 380 is connected to that draw lottery ticket.

In various embodiments, the scanner station 750 includes a lottery ticket scanner having a housing 751, a processor (not shown) supported by the housing 751, a memory device (not shown) supported by the housing 751, and an image capture device 752 supported by the housing 751. In various embodiments, the image capture device 752 includes a charge coupled device (CCD) image sensor, an active pixel sensor, and/or other suitable digital image sensor. In some embodiments, the housing includes a ticket inlet (not shown) configured to receive a printed draw lottery ticket. In some embodiments, the housing includes a ticket outlet (not shown) configured to feed a printed draw lottery ticket to the ticket spooler 755. In some such embodiments, the ticket outlet is configured to feed a roll of printed draw lottery tickets to the ticket spooler 755 (e.g., a roll of distinct draw lottery tickets that are connected to one another).

The image capture device 752 is configured to: (a) capture ticket image data for a front surface and/or a rear surface of a printed draw lottery ticket; and (b) provide the ticket image data to the terminal interceptor 740. In various embodiments, the image capture device 752 is configured to capture the ticket image data as still image(s) of the printed draw lottery ticket. In various embodiments, the image capture device 752 can include a digital camera, is not a video camera, or is not configured to capture video of the printed draw lottery ticket. In such embodiments, the ticket image data is relatively small in size as compared to video data that might be captured by a video camera. In such embodiments, the ticket image data is readily transmitted via the data network 322 (e.g., using less bandwidth, having a reduced transmission time, and using reduced processing resources). In various embodiments, the scanner station 750 includes an additional image capture device (not shown) configured to capture the ticket image data for the rear surface of the printed draw lottery ticket. In such embodiments, the image capture device 752 captures ticket image data for the front surface of the printed draw lottery ticket.

In various embodiments, the scanner station 750 includes one or more mirrors (not shown) or other reflective surfaces to enable the image capture device 752 to capture the ticket image data. In various embodiments, the scanner station 750 includes additional actuators (not shown) that are configured to present both the front surface and the rear surface of the printed draw lottery ticket to the image capture device 752, for example, by flipping the printed draw lottery ticket over, moving and/or rotating the image capture device 752, and/or moving the mirrors.

The terminal interceptor 740 is configured to receive the ticket image data from the scanner station 750. In this embodiment, the ticket image data includes an image of the actual printed draw lottery ticket instead of the augmented ticket image response 388 described above. In this embodiment, the ticket image data is enabled to include any printing errors, printing imperfections, watermarks associated with ticket printer paper, or other suitable features of the printed draw lottery ticket. In various embodiments, the terminal interceptor 740 provides the ticket image data for the printed draw lottery ticket to the eTail system 730 alternatively, or in addition to, the augmented ticket image response 388.

The ticket spooler 755 includes a housing 756 and a printed paper roll holder 757 that supports a printed lottery ticket roll. The printed paper roll holder 757 includes a spindle, curved tray or recess, or another suitable holder. In certain embodiments, the ticket spooler 755 includes roll engagers (not shown) that advance and/or guide the printed lottery ticket roll. In certain embodiments, the ticket spooler 755 includes a paper inlet port (not shown) configured to receive and/or guide the printed lottery ticket roll (e.g., along a paper winding path). The ticket spooler 755 is configured to receive and wind a printed lottery ticket roll for storage. In some embodiments, the ticket spooler 755 is configured to receive the printed lottery ticket roll printed by the lottery ticket printer 380, as described above.

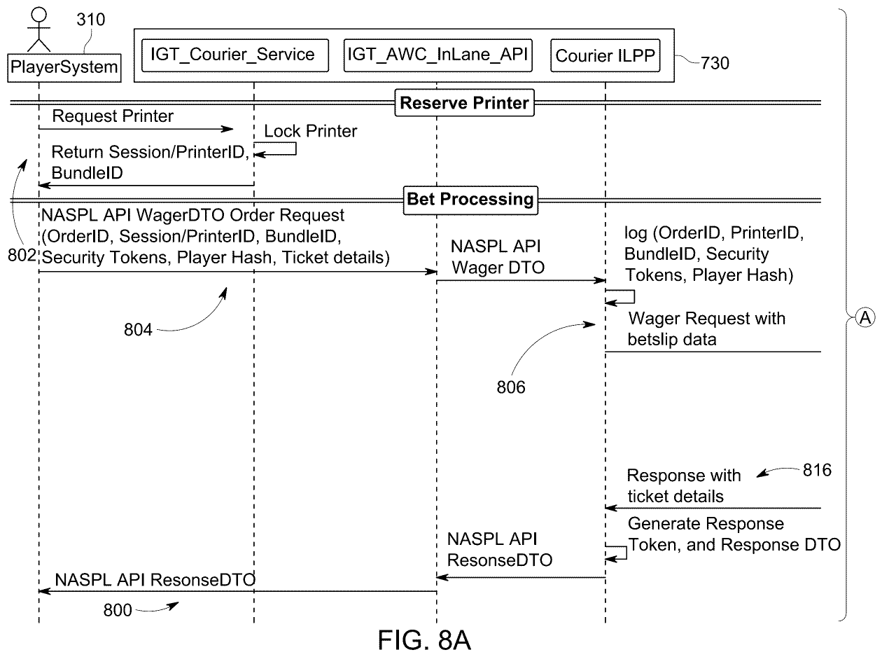

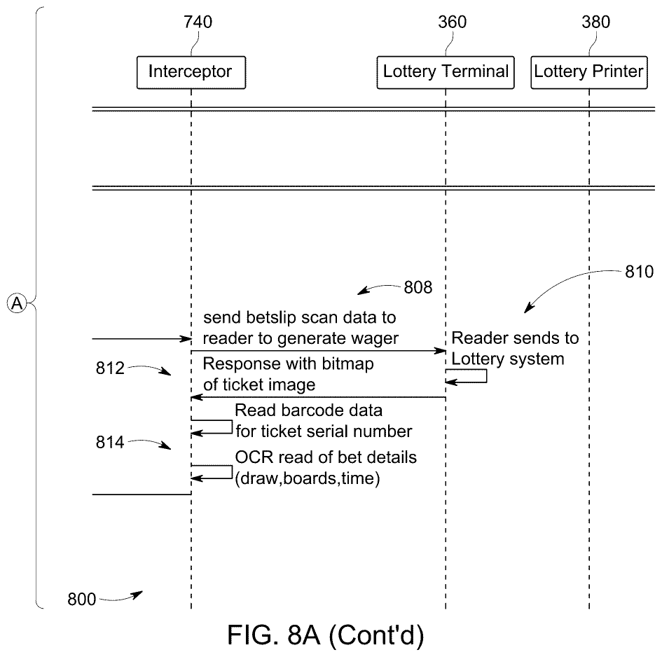

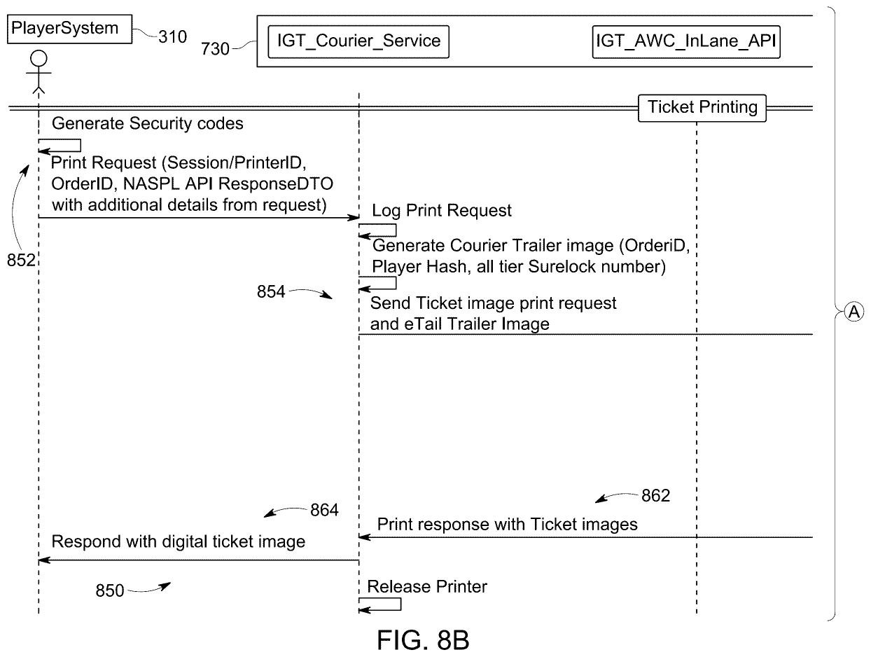

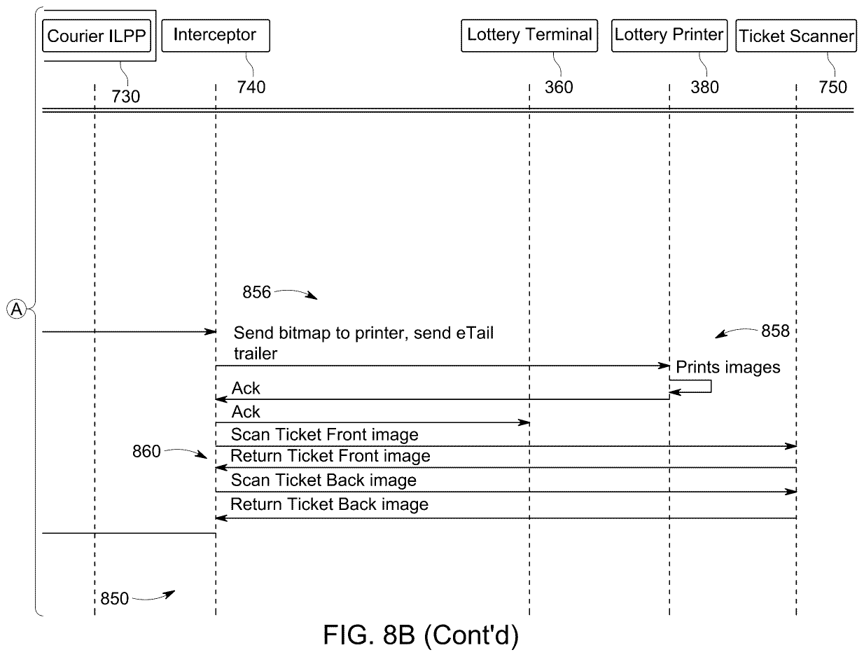

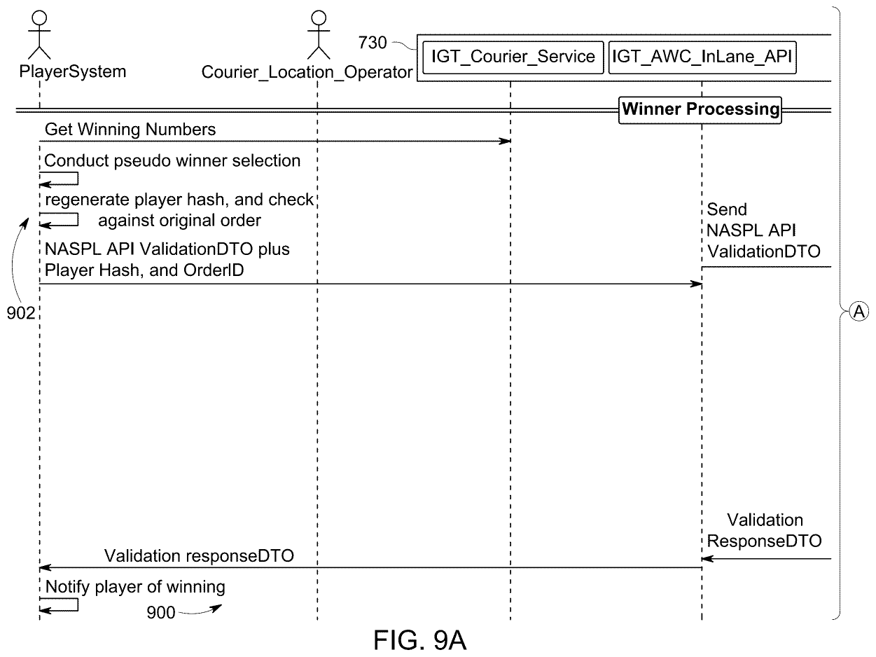

Turning to FIG. 8A, an example method 800 of operating the lottery ticket selling system 700 for a draw lottery ticket purchase by an original purchaser in accordance with one example embodiment of the present disclosure is shown and described below.

The player system 310 requests a printer, such as the lottery ticket printer 380, from the eTail system 730, as indicated at 802.

The player system 310 provides an order request to the eTail system 730, as indicated at 804. In some embodiments, the order request includes the order request 370 described above.

The eTail system 730 generates and sends a wager request to the terminal interceptor 740, as indicated at 806. In some embodiments, the wager request includes the bet slip data 372 described above.

The terminal interceptor 740 sends bet slip scan data to the lottery terminal 360, as indicated at 808. In some embodiments, the bet slip scan data includes the bet slip scan data 373 described above.

The lottery terminal 360 generates and sends a bet request for the purchase of the draw lottery ticket to the lottery central system 390 and receives a bet response. In some embodiments, the bet request includes the bet request 374 described above. In some embodiments, the bet response includes the bet response 376 described above.

The lottery terminal 360 provides a ticket image response to the terminal interceptor 740, as indicated at 812. In some embodiments, the ticket image response includes the ticket image response 382.

The terminal interceptor 740 obtains the ticket details from the ticket image response, as indicated at 814. In some embodiments, the terminal interceptor 740 employs an optical character recognition function and/or barcode reader function to obtain the ticket details 379 from the ticket image response 382, as described above.

The terminal interceptor 740 provides the ticket details to the eTail system 730 which then provides the ticket details to the player system 310, as indicated at 816. As described above, the ticket details can include the ticket serial number (e.g., ticket identifier 18), the player numbers, the security code that facilitates authentication of the purchased draw lottery ticket, and/or other suitable ticket information.

Turning to FIG. 8B, an example method 850 of operating the lottery ticket selling system 700 for printing a draw lottery ticket by an original purchaser in accordance with one example embodiment of the present disclosure is shown and described below.

The player system 310 generates and sends a print request to the eTail system 730, as indicated at 852. In various embodiments, the print request includes ticket security data, such as the security code from the ticket details 379, an order identifier associated with the lottery ticket order 370, an original purchaser identifier associated with the original purchaser (e.g., a hash of the original purchaser identifying information), and/or other suitable information.

The eTail system 730 generates and sends a ticket purchase trailer to the terminal interceptor 740 based on the print request received from the player system 310 and the ticket details, as indicated at block 854. In some embodiments, the ticket purchase trailer includes the ticket purchase trailer 386. As described above, the ticket purchase trailer 386 can include a QR code, a barcode, an image, or information in another suitable format.

The terminal interceptor 740 generates and sends an augmented ticket image response to the lottery ticket printer 380 to cause the lottery ticket printer 380 to print the printed draw lottery ticket, as indicated at 856 and 858. In some embodiments, the augmented ticket image response includes the augmented ticket image response 382.

The terminal interceptor 740 causes the scanner station 750 to capture the ticket image data for the printed draw lottery ticket and receives the ticket image data from the scanner station 750, as indicated at 860.

The terminal interceptor 740 provides the ticket image data for the printed draw lottery ticket to the eTail system 730, which then provides the ticket image data to the player system 310, as indicated at 862 and 864.

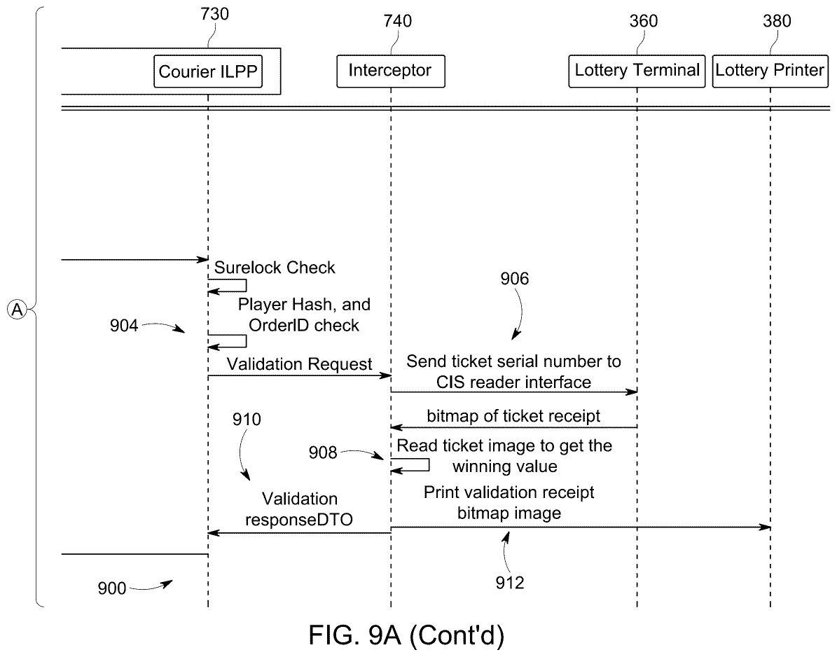

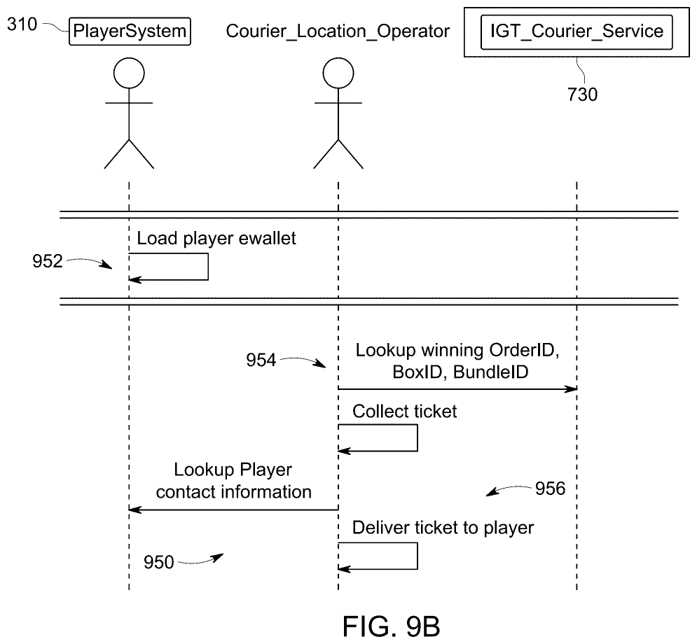

Turning to FIG. 9A, an example method 900 of operating the lottery ticket selling system 700 for validating a draw lottery ticket by an original purchaser in accordance with one example embodiment of the present disclosure is shown and described below.

In this example system and method for validating a draw lottery ticket, the player system 310 generates and sends a validation request to the eTail system 730, as indicated at 902. In various embodiments, the validation request includes ticket security data for a purchased draw lottery ticket, such as the security code from the ticket details 379, an order identifier associated with the lottery ticket order 370 for that purchased draw lottery ticket, a ticket serial number, an original purchaser identifier associated with the original purchaser (e.g., player hash), and/or other suitable information.

In various embodiments, the player system 310 and/or the eTail system 330 checks the player hash and the ticket security data to authenticate the validation request. In some embodiments, the eTail system 730 verifies that the player hash and ticket security data match previously stored ticket details for that purchased draw lottery ticket and proceeds only when the player system 310 from which the validation request is received is associated with the original purchaser of the purchased draw lottery ticket.

The eTail system 730 sends a validation request that includes the ticket serial number to the terminal interceptor 740, as indicated at 904. In some embodiments, the eTail system 730 employs a suitable application programming interface (API) to send the validation request to the terminal interceptor 740, such as a NASPL API.

The terminal interceptor 740 generates and sends ticket barcode scan data based on the ticket serial number to the lottery terminal 360 to cause the lottery terminal 360 to generate a validation receipt, as indicated at 906. The ticket barcode scan data includes the security code for the purchased draw lottery ticket. The validation receipt includes image data for the validation receipt, such as a validation image response. Based on the security code, the lottery terminal 360 validates the purchased draw lottery ticket with the lottery central system 390 and receives a validation image response for printing a validation receipt. The validation image response includes validation digital image data for the validation receipt, such as bitmap image data. The validation image response includes winning ticket details with any winning amount associated with the draw lottery ticket. The lottery terminal 360 sends the validation image response to the terminal interceptor 740.

The terminal interceptor 740 obtains the winning ticket details from the validation image response and provides the winning ticket details to the eTail system 730, as indicated at 908. In various embodiments, the terminal interceptor 740 employs an optical character recognition function to obtain the winning ticket details from the validation image response.

The terminal interceptor 740 provides the winning details to the player system 310 via the eTail system 730, as indicated at 910.

The terminal interceptor 740 provides the validation image response to the lottery ticket printer 380 for printing of the validation receipt, as indicated at 912.

Turning to FIG. 9B, an example method 950 of operating the lottery ticket selling system 700 for providing a winning amount for a winning draw lottery ticket to an original purchaser in accordance with one example embodiment of the present disclosure is shown and described below.

The player system 310 employs the winning details received from the eTail system 730 and determines whether the winning draw lottery ticket is below a “low tier” threshold, such as $600 in this example embodiment.

If the winning amount is less than $600, the player system 310 and/or the eTail system 730 automatically credit the winning amount for the draw lottery ticket to the original purchaser's account, as indicated at 952.

If the winning amount is more than $600, the player system 310 and/or the eTail system 730, a courier processing clerk retrieves the stored winning draw lottery ticket from a courier storage location and sends that printed draw lottery ticket to the original purchaser so that the original purchaser can cash in that lottery ticket and obtain the winning amount, as indicated at 954 and 956.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket selling system comprising:
a lottery terminal comprising a printer connector and a code reader connector that is connectable to a code reader;
a lottery ticket printer associated with the lottery terminal and comprising a terminal connector that is connectable to the printer connector;
a terminal interceptor comprising:
a terminal code reader connector connected to the code reader connector of the lottery terminal;
a terminal printer connector connected to the printer connector of the lottery terminal;
a printer terminal connector connected to the terminal connector of the lottery ticket printer; and
an interceptor processor and an interceptor memory device that stores a first plurality of instructions; and
an electronic ticket retail server comprising a server processor and a server memory device that stores a second plurality of instructions, which when executed by the server processor, cause the server processor to:
receive a lottery ticket order from a player electronic device associated with an original purchaser, the lottery ticket order comprising bet details for a purchase of a draw lottery ticket;
generate a ticket purchase identifier for the draw lottery ticket prior to the purchase of the draw lottery ticket, wherein the original purchaser is uniquely identifiable using the ticket purchase identifier;
generate bet slip data that comprises the bet details for the draw lottery ticket; and
send the bet slip data to the terminal interceptor;
wherein the first plurality of instructions stored on the interceptor memory device, when executed by the interceptor processor, cause the interceptor processor to:
generate bet slip scan data based on the bet slip data;
send the bet slip scan data to the lottery terminal via the terminal code reader connector to cause the purchase of the draw lottery ticket based on the bet slip scan data;
receive a ticket image response from the lottery terminal via the terminal printer connector, the ticket image response comprising ticket details for the purchased draw lottery ticket;
obtain the ticket details from the ticket image response and send the ticket details to the electronic ticket retail server;
wherein the second plurality of instructions stored on the server memory device, when executed by the server processor, cause the server processor to:
generate a ticket purchase trailer that comprises the ticket purchase identifier and send the ticket purchase trailer to the terminal interceptor; and
wherein the first plurality of instructions stored on the interceptor memory device, when executed by the interceptor processor, cause the interceptor processor to:
generate an augmented ticket image response based on the ticket image response and the ticket purchase trailer; and
send the augmented ticket image response to the lottery ticket printer via the printer terminal connector to cause the lottery ticket printer to print the purchased draw lottery ticket, the printed draw lottery ticket comprising the ticket details and the ticket purchase trailer.

2. The lottery ticket selling system of claim 1, wherein the ticket purchase identifier comprises an original purchaser identifier that is employable to associate the purchased draw lottery ticket with the original purchaser and to identify the original purchaser.

3. The lottery ticket selling system of claim 2, wherein the original purchaser identifier comprises an original purchaser digital signature that does not by itself uniquely identify the original purchaser.

4. The lottery ticket selling system of claim 1, wherein:
the bet details comprise a draw game identifier that identifies a lottery game type, a draw date, and player numbers for the purchase of the draw lottery ticket; and
the ticket details comprise a draw game identifier for the purchased draw lottery ticket, a draw date for the purchased draw lottery ticket, and player numbers for the purchased draw lottery ticket.

5. The lottery ticket selling system of claim 4, wherein the ticket purchase identifier is independent from the ticket details.

6. The lottery ticket selling system of claim 1, wherein the first plurality of instructions stored on the interceptor memory device, when executed by the interceptor processor, cause the interceptor processor to send the augmented ticket image response to the player electronic device via the electronic ticket retail server.

7. The lottery ticket selling system of claim 1, wherein the first plurality of instructions stored on the interceptor memory device, when executed by the interceptor processor, cause the interceptor processor to generate the augmented ticket image response such that the lottery ticket printer prints the printed draw lottery ticket and the ticket purchase trailer onto a same ticket substrate.

8. The lottery ticket selling system of claim 1, wherein the terminal interceptor further comprises a betslip reader emulator that sends the bet slip scan data to the lottery terminal via the terminal code reader connector by emulating the code reader that is connectable to the code reader connector.

9. The lottery ticket selling system of claim 1, wherein the terminal interceptor further comprises a printer emulator that receives the ticket image response by emulating the lottery ticket printer.

10. The lottery ticket selling system of claim 1, wherein the terminal interceptor further comprises a lottery terminal emulator that sends the augmented ticket image response to the lottery ticket printer via the printer terminal connector by emulating the lottery terminal.

11. A lottery ticket selling system comprising:
a terminal interceptor comprising:
a terminal code reader connector that is connectable to a code reader connector of a lottery terminal;
a terminal printer connector that is connectable to a printer connector of the lottery terminal;
a printer terminal connector that is connectable to a terminal connector of a lottery ticket printer; and
an interceptor processor and an interceptor memory device that stores a first plurality of instructions;
wherein the first plurality of instructions stored on the interceptor memory device, when executed by the interceptor processor, cause the interceptor processor to:
receive, from an electronic ticket retail server, bet slip data that comprises bet details for a purchase of a draw lottery ticket for an original purchaser;
generate bet slip scan data based on the bet slip data;
send the bet slip scan data to the lottery terminal via the terminal code reader connector to cause the purchase of the draw lottery ticket based on the bet slip scan data;
receive a ticket image response from the lottery terminal via the terminal printer connector, the ticket image response comprising ticket details for the purchased draw lottery ticket;
obtain the ticket details from the ticket image response and send the ticket details to the electronic ticket retail server;
receive a ticket purchase trailer that comprises a ticket purchase identifier, wherein the original purchaser is uniquely identifiable using the ticket purchase identifier;
generate an augmented ticket image response based on the ticket image response and the ticket purchase trailer; and
send the augmented ticket image response to the lottery ticket printer via the printer terminal connector to cause the lottery ticket printer to print the purchased draw lottery ticket, the printed draw lottery ticket comprising the ticket details and the ticket purchase trailer.

12. The lottery ticket selling system of claim 11, wherein the terminal interceptor further comprises a betslip reader emulator that sends the bet slip scan data to the lottery terminal via the terminal code reader connector by emulating a code reader that is connectable to the code reader connector.

13. The lottery ticket selling system of claim 11, wherein the terminal interceptor further comprises a printer emulator that receives the ticket image response by emulating the lottery ticket printer.

14. The lottery ticket selling system of claim 11, wherein the terminal interceptor further comprises a lottery terminal emulator that sends the augmented ticket image response to the lottery ticket printer via the printer terminal connector by emulating the lottery terminal.

15. The lottery ticket selling system of claim 11, wherein:
the printed draw lottery ticket comprises a substrate with a draw ticket QR code printed thereon; and
the draw ticket QR code comprises the ticket purchase identifier.

16. The lottery ticket selling system of claim 15, wherein the draw ticket QR code comprises the ticket details.

17. The lottery ticket selling system of claim 16, wherein the ticket details comprise a draw game identifier for the purchased draw lottery ticket, a draw date for the purchased draw lottery ticket, and player numbers for the purchased draw lottery ticket.

18. A lottery ticket selling system comprising:
a lottery ticket scanner;
a terminal interceptor comprising:
a terminal code reader connector that is connectable to a code reader connector of a lottery terminal;
a terminal printer connector that is connectable to a printer connector of the lottery terminal;
a printer terminal connector that is connectable to a terminal connector of a lottery ticket printer; and
an interceptor processor and an interceptor memory device that stores a first plurality of instructions; and
an electronic ticket retail server comprising a server processor and a server memory device that stores a second plurality of instructions, which when executed by the server processor, cause the server processor to:
receive a lottery ticket order from a player electronic device associated with an original purchaser, the lottery ticket order comprising bet details for a purchase of a draw lottery ticket;
generate a ticket purchase identifier for the draw lottery ticket prior to the purchase of the draw lottery ticket, wherein the original purchaser is uniquely identifiable using the ticket purchase identifier;
generate bet slip data that comprises the bet details for the draw lottery ticket; and
send the bet slip data to the terminal interceptor;
wherein the first plurality of instructions stored on the interceptor memory device, when executed by the interceptor processor, cause the interceptor processor to:
generate bet slip scan data based on the bet slip data;
send the bet slip scan data to the lottery terminal via the terminal code reader connector to cause the purchase of the draw lottery ticket based on the bet slip scan data;
receive a ticket image response from the lottery terminal via the terminal printer connector, the ticket image response comprising ticket details for the purchased draw lottery ticket;
obtain the ticket details from the ticket image response and send the ticket details to the electronic ticket retail server;
wherein the second plurality of instructions stored on the server memory device, when executed by the server processor, cause the server processor to:
generate a ticket purchase trailer that comprises the ticket purchase identifier and send the ticket purchase trailer to the terminal interceptor; and
wherein the first plurality of instructions stored on the interceptor memory device, when executed by the interceptor processor, cause the interceptor processor to:
generate an augmented ticket image response based on the ticket image response and the ticket purchase trailer;
send the augmented ticket image response to the lottery ticket printer via the printer terminal connector to cause the lottery ticket printer to print the purchased draw lottery ticket such that the lottery ticket scanner can scan the printed draw lottery ticket to obtain scanned draw lottery ticket data, the printed draw lottery ticket comprising the ticket details and the ticket purchase trailer; and
receive the scanned draw lottery ticket data from the lottery ticket scanner and send the scanned draw lottery ticket data to the player electronic device via the electronic ticket retail server.

19. The lottery ticket selling system of claim 18, wherein the first plurality of instructions stored on the interceptor memory device, when executed by the interceptor processor, cause the interceptor processor to generate the augmented ticket image response such that the lottery ticket printer prints the printed draw lottery ticket onto a printed lottery ticket roll comprising a plurality of draw lottery tickets.

20. The lottery ticket selling system of claim 19, wherein:
the lottery ticket selling system further comprises a ticket spooler comprising a housing and a printed paper roll holder;
wherein the ticket spooler winds the printed lottery ticket roll from the lottery ticket printer onto the printed paper roll holder for storage of the plurality of draw lottery tickets.
